(19) United States
(12) Patent Application Publication
(10) Pub. No.: US 2017/0096031 A1
(43) Pub. Date: Apr. 6, 2017

(54) TIRE, VEHICLE MOUNTED WITH SAID TIRE, AND COMMUNICATION CONTROL SYSTEM

(71) Applicant: HighFrequency ViscoElasticity Corporation, Kanagawa (JP)

(72) Inventor: Nobuaki Omata, Kanagawa (JP)

(21) Appl. No.: 15/379,638

(22) Filed: Dec. 15, 2016

Related U.S. Application Data
(63) Continuation of application No. PCT/JP2015/073913, filed on Aug. 25, 2015.

(30) Foreign Application Priority Data
Aug. 25, 2014 (JP) 2014-170825
Sep. 10, 2014 (JP) 2014-184080
Oct. 2, 2014 (JP) 2014-203820

(51) Int. Cl. B60C 11/00; B60C 19/00

(52) U.S. Cl. CPC B60C 11/0008; B60C 19/00

(57) ABSTRACT

A tire having a tread member which has a contact surface made of an elastomer whose viscoelasticity is changed by applying an electric field or a magnetic field, which affords an advantage of enabling control of hysteresis loss near the contact surface of the tread member of the tire.

### CROSS-REFERENCE TO RELATED APPLICATIONS

This application is a continuation of PCT International Patent Application No. PCT/JP2015/073913 filed Aug. 25, 2015, which claims the benefit of Japanese Patent Application No. 2014-203820, filed Oct. 2, 2014, Japanese Patent Application No. 2014-184808, filed Sep. 10, 2014, and Japanese Patent Application No. 2014-170825, filed Aug. 25, 2014, the disclosure of each of these applications are expressly incorporated herein by reference in their entireties.

### TECHNICAL FIELD

The present invention relates to a tire attached to a transportation means such as a vehicle which runs on land and which includes a motorcycle, a car having more than three wheels, and the like, a vehicle which runs on a rail and which includes a monorail, freight car used in a factory, and the like, and an airplane and the like, a vehicle to which the tire is attached, and a transportation control system.

Also, the present invention relates to a friction property measurement device and a method for the friction property measurement which measure a friction property which can be used as an index for development of elastomers which are used for functional parts using friction force, such as a roller, a tire, and the like, and, especially, whose viscoelasticity properties are changed by applying an electric field or a magnetic field.

Also, the present invention relates to a viscoelasticity measurement device and a method thereof which measure a viscoelasticity property of elastomers whose properties are changed by applying the electrical field or the magnetic field.

### BACKGROUND ART

Various performances are required in tires, and as a recent tendency, improvement on grip force and achievement of fuel saving at the same time are required. In order to meet the requirements, tire manufactures try to improve the performance of the tire by improving structures of the tire and its tread pattern, developing a rubber material for the tire, and the like, and due to their effort, the performances of tires have been gradually improved. However, it is difficult to achieve a drastic improvement by the above-described improvements and developments, because the improvement of the grip force and achieving the fuel saving are opposite ideas.

On the other hand, in response to the above-described requirements, a tire which can change air pressure therein on the basis of various road surface conditions by utilizing the fact that rolling resistance is reduced when air pressure becomes higher, and that grip force is increased when air pressure becomes lower, and by mounting an electrical valve having a small compressor which can control air pressure in the tire which is attached to the vehicle is known. (See PTL 1, for example.)

Also, there is a known tire having an elastomer which expands and contracts by applying an electric field is attached to its inner circumference surface, utilizing the fact that performance of the tire is changed when a solidity of the tire itself is changed. (See PTL 2, for example.) With this tire, the property of the tire can be changed in response to operational condition, such as vehicle speed, presence of curves, and the like, and road surface condition, because the tire expands in the radial direction and the solidity of the tire becomes larger when the electric field is applied to the elastomer.

### CITATION LIST

### Patent Literature

### PTL 1 Japanese Unexamined Patent Application Publication No. 2013-28338

### PTL 2 Japanese Unexamined Patent Application Publication No. 2008-87512

### PTL 3 Japanese Patent No. 3215579

### PTL 4 Japanese Unexamined Patent Application Publication No. 2008-107306

### SUMMARY OF INVENTION

A tire according to a first aspect of the present invention comprises a tread member which has a contact surface made of an elastomer whose viscoelasticity is changed by applying an electric field or a magnetic field.

### BRIEF DESCRIPTION OF DRAWINGS

FIG. 1 is a sectional view showing a tire according to a first embodiment of the present invention.

FIG. 2 is a sectional view showing a tread member in an unvulcanized state which is used for the tire.

FIG. 3 is a sectional view showing the tread member in an unvulcanized state which is used for the tire.

FIG. 4 is a sectional view of an essential portion of the tire according to a first modification of the first embodiment.

FIG. 5 is a block diagram of a controller which controls the tire of the first embodiment.

FIG. 6 is a block diagram of a traffic control apparatus which controls the tire of the first embodiment.

FIG. 7 is a sectional view showing a tread member in an unvulcanized state which is used for a tire according to a second modification of the first embodiment.

FIG. 8 is a sectional view of a second ribbon-shaped rubber which is used for a tire according to a third modification of the first embodiment.

FIG. 9 is a sectional view showing a tire according to a forth modification of the first embodiment.

FIG. 10 is a planar view showing an essential part of a tire according to a second embodiment.

FIG. 11 is a planar view showing an essential part of a tire according to a modification of the second embodiment.

FIG. 12 is a front view showing a friction property measurement device according to a third embodiment of the present invention.

FIG. 13 is a plane view of the friction property measurement device according to the third embodiment.

FIG. 14 is a front view and a side view of a roller of the friction property measurement device according to the third embodiment.

FIG. 15 is a measurement result example of the friction property measurement device according to the third embodiment.

FIG. 16 is a measurement result example of the friction property measurement device according to the third embodiment.

FIG. 17 is a measurement result example of the friction property measurement device according to the third embodiment.

FIG. 18 is a front view of the friction property measurement device of a forth embodiment of the present invention.

FIG. 19 is a measurement result example of the friction property measurement device of the fourth embodiment.

FIG. 20 is a measurement result example of the friction property measurement device of a fifth embodiment.

FIG. 21 is a schematic view of a viscoelasticity property measurement device of a sixth embodiment of the present invention.

FIG. 22 is a schematic view of a transmission/reception circuit and a measurement controller of the sixth embodiment.

FIG. 23 is an example of a derived result of the viscoelasticity property of the sixth embodiment.

FIG. 24 is an example of a derived result of the viscoelasticity property of the sixth embodiment.

FIG. 25 is a schematic view showing a viscoelasticity property measurement device according to a seventh embodiment of the present invention.

FIG. 26 is a schematic view showing the viscoelasticity property measurement device according to an eighth embodiment of the present invention.

FIG. 27 is a schematic view showing a modification of the viscoelasticity property measurement device of the sixth embodiment.

### DESCRIPTION OF EMBODIMENTS

A tire in accordance with a first embodiment of this present invention is described below with reference to the drawings.

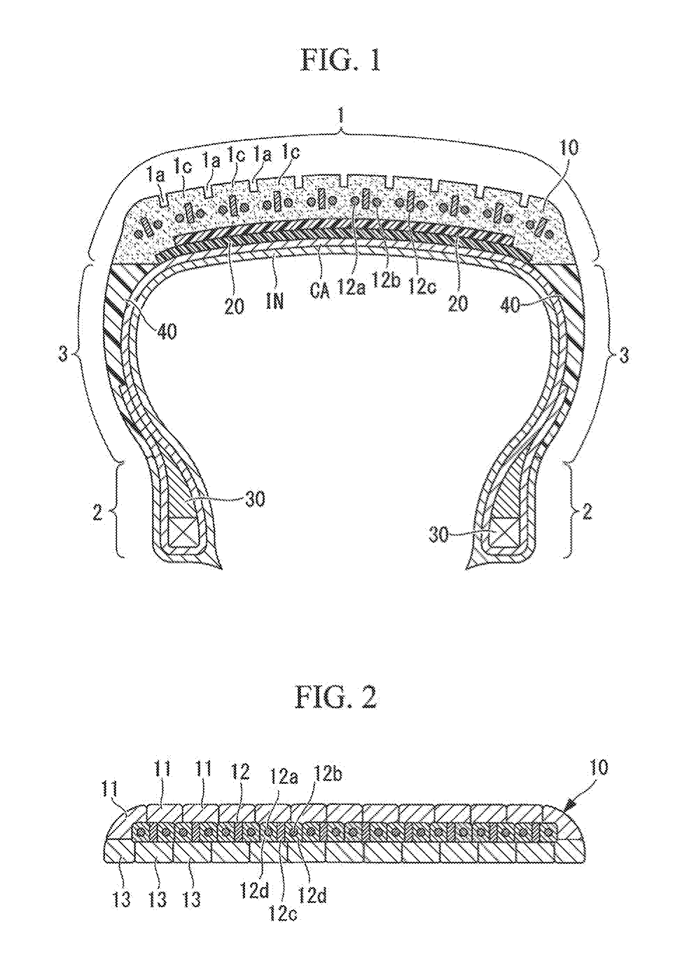

This tire has an inner liner member IN, a carcass member CA, a belt member 30, a bead member 30, a side member 40, and the like, and used for a motorcycle, a vehicle, such as a car, having more than three wheels, a vehicle which runs on a rail, such as a monorail, a freight car, and the like. However, different kinds of tire constituting members may be provided depending on requirements of the tire, and some of the tire constituting members may be omitted. This tire comprises, as shown in FIG. 1, a tread portion 1 which comes into contact with a road surface, a pair of bead portions 2 provided at both sides of the tire width direction and mounted on the rims (not shown) of a wheel, and a pair of side portions 3 respectively extending toward the radial direction of the tire from the bead portions 2. The both of the end portions in the width direction of the tread portion 1 are also referred to as shoulder portions. A plurality of vertical grooves 1a and a plurality of lateral grooves are formed on the outer surface of the tread portion 1, a plurality of blocks 1c are formed by the grooves, and a tread pattern is formed by the grooves and the blocks 1c.

When forming the tire, for example, in a state in which the tire constituting members are not vulcanized, an unvulcanized tire is made by forming the inner liner member IN into a cylindrical shape on a shaping drum, winding the carcass member CA around the outer circumference surface thereof, mounting the pair of bead members 30 on the outer circumference surface of the carcass member CA and winding the pair of side members 40 thereonto, shaping the cylindrical member into a doughnut-like shape, and winding the two belt members 20 and the tread member 10 around the outer circumference surface of the cylindrical member which has been formed into the doughnut-like shape. And the tire shown in FIG. 1 is formed by applying pressure and heat to the unvulcanized tire in a vulcanization mold.

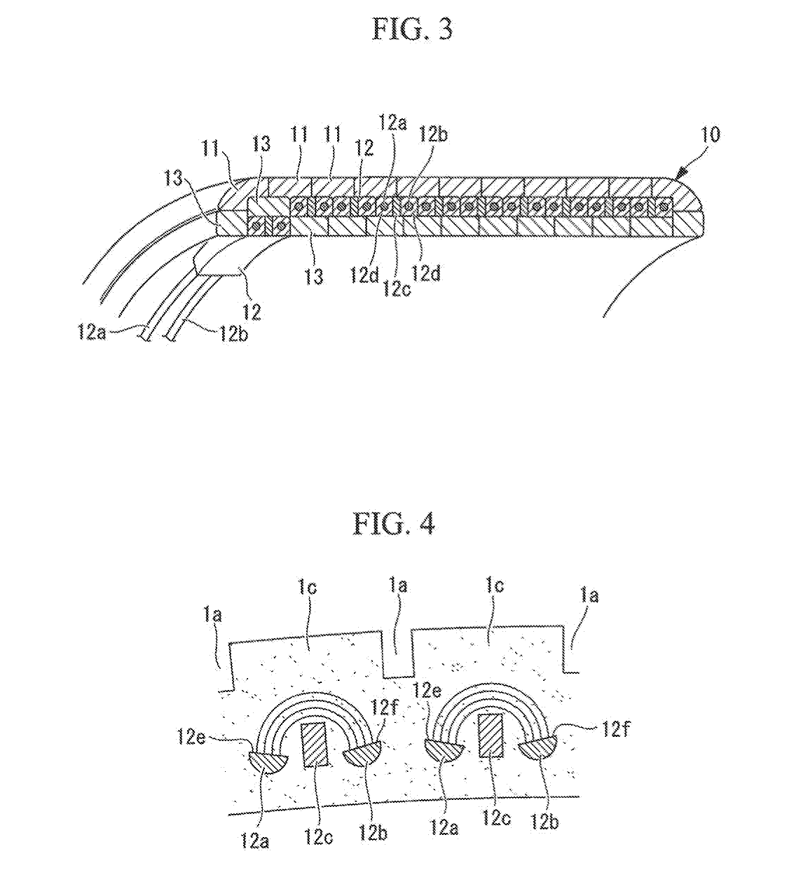

The tread member 10 in the unvulcanized state is formed in a cylindrical shape as shown in FIGS. 2 and 3 by winding a ribbon-shaped unvulcanized rubber. Also, the unvulcanized tread member 10 has a first ribbon-shaped rubber 11 which is wound at the outermost circumference surface side and on which grooves 1a, 1b and the blocks 1c are formed after vulcanization in the mold so that the first ribbon-shaped rubber 11 becomes a contact surface, a second ribbon-shaped rubber 12 wound at the inner circumferential surface side of the first ribbon-shaped rubber 11, and a third ribbon-shaped rubber 13 wound at the inner circumference surface side of the second ribbon-shaped rubber 12. The first ribbon-shaped rubber is made of an elastomer whose viscoelasticity property changes by applying an electrical field or a magnetic field. The second ribbon-shaped rubber includes a pair of electrodes 12a, 12b, a low permittivity member 12c disposed between the pair of electrodes 12a, 12b, and a unvulcanized rubber portion 12d connecting the pair of electrodes 12a, 12b and the low permittivity member 12c. In this embodiment, although the unvulcanized rubber portion 12d is made of a material for forming a conventional tread rubber portion, such as a natural rubber, it may be made of the elastomer whose viscoelasticity property changes by applying the electrical field and the magnetic field like the first ribbon-shaped rubber 11. The electrodes 12a and 12b are made of metal wire, and are insulated from each other by the unvulcanized rubber portion 12d. The low permittivity member 12c is made of a rubber, a plastic, or another kind of elastic material such as a high polymer material having permittivity equal to or less than ½ of that of the elastomer of the first ribbon-shaped rubber 11. When the low permittivity member 12c is made of a rubber material, an unvulcanized rubber may be used, and alternatively a vulcanized rubber may be used. Like the low permittivity member 12c, the third ribbon-shaped rubber 13 is also made of a rubber having permittivity equal to or less than ½ of that of the first ribbon-shaped rubber 11.

After winding the two belt members 20 around the cylindrical member which is formed in the doughnut-like shape, the tread member 10 may be formed by winding the third, the second, and the first ribbon-shaped rubbers with this order around the outer circumference surface of the belt members 20. The both ends of the second ribbon-shaped rubber 12 of the tread member 10, one end of which is shown in FIG. 3, is protruding toward the inside in the tire radial direction. In this embodiment, after winding the tread member 10 around the cylindrical member which has been formed in the doughnut-like shape, the both ends of the second ribbon-shaped rubber 12 are protruded in the tire radial direction and toward the inside of the cylindrical member by making the both ends of the second ribbon-shaped rubber 12 penetrate and/or pass through the constructional elements of the cylindrical member, alternatively, the both ends of the second ribbon-shaped rubber 12 may be protruded in the tire radial direction and toward the outside of the cylindrical member through a portion between the side member 40 and the bead member 30 or the like.

As the elastomer whose viscoelasticity property changes by means of applying electric field and magnetic field, for example, a polypyrrole, a polythiophene, a polyaniline, a polyphenylene, and the like disclosed in Japanese Unexamined Patent Application Publication No. 2005-111245 may be used, a polyurethane disclosed in the Japanese Unexamined Patent Application Publication No. H07-240544 may also be used, a silicone rubber disclosed in the Japanese Examined Patent Application Publication No. H06-41530 may also be used, an electroconductive polymer structure comprises a hydrophilic ionic fluid composed of a cationic component and an anionic component disclosed in the Japanese Unexamined Patent Application Publication No. 2010-155918 may also be used, a liquid crystal elastomer disclosed in the Japanese Unexamined Patent Application Publication No. 2009-191117 may also be used, a high polymer material in which a fibrous or particle ferromagnetic material and a reinforcing material are dispersed, and to which the fibers or the particles are orientated by the magnetic field may also be used, and a high polymer material in which fibers or particles, which are oriented by the electric field or the magnetic field, are dispersed may be used.

The elastomer whose viscoelasticity changes by applying the electric field or the magnetic field is dielectric as a capacitor is, it may be possible to polarize by making potential difference and self-holding the polarized state and by cutting a circuit to be a state without electrical current. In such case, the polarized state disappears by a short circuit, and an original property of a material is exhibited. On the other hand, the following thing has not been described though, when a material whose storage elastic modulus decreases and whose loss elastic modulus increases by polarization is used, the loss tangent becomes increased and a grip force becomes enlarged, and therefor rolling resistance becomes larger by having influence thereof. Materials to use will be decided in accordance with a balance of requirements corresponding to the usage considering safety, grip force and fuel saving.

By applying molding process to the unvulcanized tire having such tread member in the vulcanization mold, the grooves 1a, 1b and the blocks 1c are formed on a portion corresponding to the first ribbon-shaped rubber 11, and each pair of electrode 12a, 12b and its low permittivity member 12c disposed between the pair of electrodes 12a, 12b are disposed at the raduak inside of each of the blocks 1c. By this, the pair of electrodes 12a, 12b and the low permittivity member 12c are spirally disposed in the tire circumferential direction.

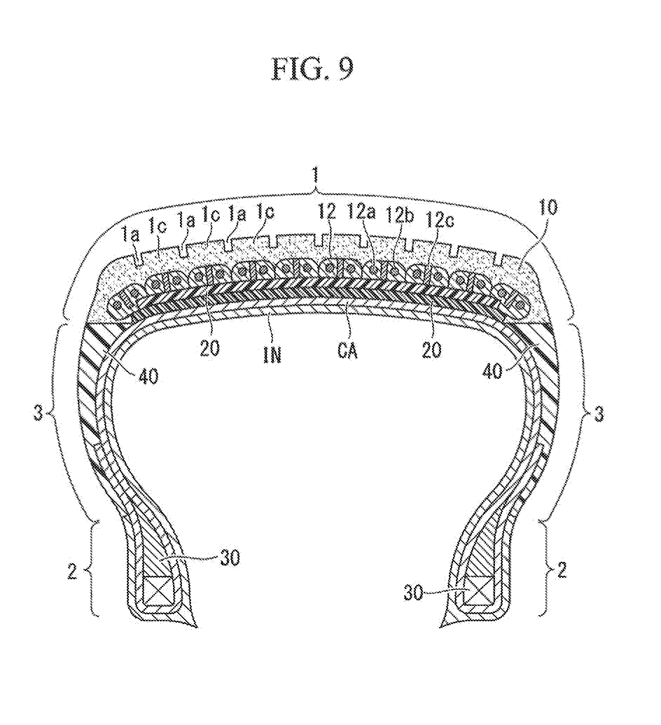

In this embodiment, the second ribbon-shaped rubber 12 is wound at the inside of the tread member 10, and the electrodes 12a, 12b are arranged inside the tread member 10. On the other hand, it is also possible to wind the second ribbon-shaped rubber 12 between the tread member 10 and the belt member 20, and place the electrodes 12a, 12b in the ribbon-shaped rubber 12 which is spirally wound at a radial inside of the tread member 10 (refer to FIG. 9). The ribbon-shaped rubber may be provided as a part of the belt member 20.

Also, in this embodiment, the both ends of the second ribbon-shaped rubber 12 is disposed at a radial inside of the tread portion 1 and between the pair of side portions 3 of the vulcanized tire. This tire is used by attaching the bead portions 2 of this tire to the rim portions of a vehicle wheel, and filling the inside of the tire with air to a predetermined pressure. At this stage, the pair of electrodes 12a, 12b are connected to a power supply unit 60. The power supply unit 60 may be provided in the wheel or it may be provided in the vehicle. When the power supply unit 60 is provided in the wheel or the vehicle, the both ends of the pair of electrodes 12a, 12b are connected to a rotary joint, and via the rotary joint, electric potentials are provided to the pair of electrodes 12a, 12b from the power supply unit 60. Alternatively, it is possible to provide the electric potentials to the pair of electrodes 12a, 12b from a power generation element or a power storage element by attaching the power generation element or the power storage element to the side portion 3 or the tread portion 1 of this tire, and by connecting the pair of electrodes 12a, 12b to the power generation element or the power storage element. When attaching the power generation element, the power generation element is made of a piezoelectric element or the like, and electric energy is generated by repetitive deformation of the tire.

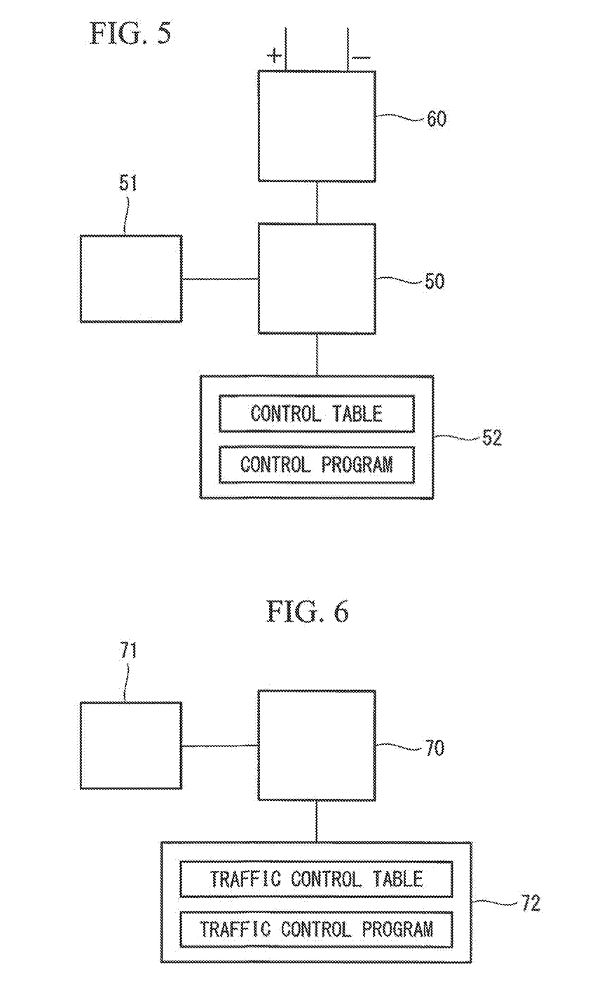

As shown in FIG. 5, a control device 50 which is connected to the power supply unit 60, and which controls the electrical potentials supplied to the electrodes 12a, 12b depending on an operation state or a behavior of the vehicle is provided. The control device 50 has a known computer, and includes a detection portion 51 for detecting the operation state or the behavior of the vehicle, and a storage portion 52 for storing a control program and a control table for associating value ranges of the detected values detected by the detection portion 51 with electrical potentials. The detecting portion 51 may be a speedometer, a steering angle detector, an accelerometer provided in the vehicle for detecting acceleration of each of the directions of the vehicle or the tire, a surface condition detection means for detecting temperature and condition of the road surface, a thermometer for detecting outside temperature of the vehicle 60, and a weight sensor for detecting a vehicle weight, it is also possible to use a detecting means for detecting different kinds of operation states and the behavior of the vehicle, and one or plurality of the aforementioned elements may be used. Further, for the detection of the operation state and the behavior, a signal such as a signal generated by an inverse piezoelectric effect of the tire of this embodiment, known ABS control signals, a tire acceleration sensor, a tire strain sensor and the like may be used. The control device 50 is operated by the control program, and the control device 50 operates the power supply unit 60 in response to detection results of the detection portion 51. By this, an electrical potential on the basis of a detection result of the detection portion 51 is supplied to the pair of electrodes 12a, 12b. At this time, the control device 50 refers to the control table, and therefore electrical potential corresponding to the detection result of the detection portion 51 is supplied.

For example, if the detecting portion 51 detects speed of the vehicle being more than a predetermined value, and the steering angle being less than a predetermined value, a larger potential difference will be supplied to the pair of electrodes 12a, 12b. With this configuration, electric flux density going through the block portions 11c becomes higher, and hysteresis loss of the elastomer which the blocks 11c are made of becomes smaller. Especially, low frequency hysteresis loss (values of damping coefficient, storage elastic modulus, loss elastic modulus, loss tangent, and the like) of the elastomer which the blocks 11c are made of becomes smaller. With his configuration, the rolling resistance of the tire becomes smaller, and driving with fuel saving can be realized. On the other hand, when the detection portion 51 detects speed of the vehicle being more than a predetermined value, and the steering angle being more than a predetermined value, potential difference supplied to the pair of electrodes 12a, 12b will be small or zero. By this, the electric flux density going through the blocks 11c becomes low or zero, the hysteresis loss of the elastomer which the block 11c is made of becomes bigger. Especially, high frequency hysteresis loss (values of damping coefficient, storage elastic modulus, loss elastic modulus, loss tangent, and the like) of the elastomer which the block 11c are made of becomes bigger. The high frequency hysteresis loss has a large influence on a grip force, especially wet grip force of the tire, therefore, the grip force, especially the wet grip force of the tire becomes larger.

With the aforementioned configuration, since the rolling resistance can be decreased by changing a material property with low electrical potential and in a short time relative to conventional methods which improve rigidity for supporting the vehicle, and since the wet grip force based on the hysteresis loss of the tread rubber itself, which has been limited for fuel saving, can be larger than it used to be, in addition to decrease of the contact area by increasing the rigidity of the tire case, and in addition to an improvement on energy loss which is caused by a deformation of the tire, the range, in which fuel consumption during steady driving and improved grip force in emergency and sport driving are realized at the same time, can be broaden by adjusting friction frequency property itself on the tread surface.

Further, as shown in FIG. 6, it is also possible to provide a traffic control device 70 which is provided in a vehicle or at a control center distant from the vehicle, for sending a control signal for controlling the electrical potential to be supplied to the electrodes 12a, 12b on the basis of the operation state of the vehicle, behavior of the vehicle, condition of the road surface, weather, a traffic condition, and the like. The traffic control device 70 has a known computer, and also has a condition detection portion 71 for detecting conditions of road surfaces and weather, and a memory 72 for storing a traffic control program and a traffic control table for associating value ranges or conditions detected by the condition detection portion 71 with electrical potentials. The condition detection portion 71 may receive an information of weather from a meteorological observation organization such as the Meteorological Agency, it may presume a condition of the road surface from an obtained weather information and a quality of the road surface of its corresponding place, it may be placed on the road surface of the corresponding place so as to measure or observe a condition of the road surface directly, it may receive a traffic information from an organization collecting and managing information of traffic condition, it may presume traffic information of the road based on a sensor and a camera placed on the corresponding road, it may be the detection portion 51, and it may use one or plurality of the above. The traffic control device 70 is operated on the basis of the traffic control program, the traffic control device 70 sends the control signal for controlling the electrical potential, which is supplied to the electrodes 12a, 12b, to the control device 50 of the vehicle. With this configuration, the electrical potential corresponding to the detection result of the condition detection portion 71 is supplied to the pair of electrodes 12a, 12b from the power supply unit 60. At this time, the traffic control device 70 refers to the traffic control table, and by this, the electrical potential corresponding to the detection result of the traffic detection portion 71 is supplied. Also, the control signal may be sent not only to one vehicle, but also to the control means 50 of a vehicle existing in a predetermined area. With this configuration, the grip force of the tire may forcibly be increased when snowing or the like.

Further, each of the vehicles may include a location information detection means for detecting a location information of the vehicle, the control device of each of the vehicles may be configured so as to send a control result of electric supplied to the electrodes 12a, 12b and the detection results of the detection portion 51 which is used in the control, together with the location information at the time of controlling and detecting the vehicle, to the traffic control device 71. At this time, the traffic control device 71 stores the control result received from the vehicles and the information of the detection result so as to be associated with the location information of vehicle at the time of controlling and detecting. By using such data, it becomes possible to estimate technique of a driver and safety of the vehicle.

In addition, when the vehicles has an automatic driving means for allowing the vehicle to be driven at a fixed speed on a highway and the like, and semi-automatic driving means for allowing the vehicle to conduct an avoidance operation when danger is approaching, the control device 50 may be configured so as to control the electrical potential supplied to the electrodes 12a, 12b on the basis of the control signal from the detecting portion 51 and the traffic control device 71.

As described above, with this embodiment, the hysteresis loss near the contact surface of the tread member 10 can be adjusted by changing the viscoelasticity of the elastomer which forms the contact surface of the tread member 10 by applying the electric field to the contact surface side of the tread member 10.

For example, at the time of an ordinary driving with a certain speed, the rolling resistance can be reduced and fuel consumption can be improved by applying the electrical field. At the time of an urgency breaking or a sudden acceleration, or when raining and snowing, the electrical field may be cut so as to provide the maximum grip force. Also, it may be used for controlling traction of the tires when turning.

Further, in the tread member 10 on which the contact surface is formed, or in the tire constituting member located inside of the tread member 10, the plurality of electrodes 12a, 12b are located. Therefore, it is not necessary to provide the electrodes 12a, 12b in a member other than the tire. With this configuration, the configuration around the tire can be simplified. Moreover, since the tire constituting member located inside of the tread member 10 is located at a vicinity of the tread member 10, the electric field or the magnetic field can be efficiently applied to the contact surface side of the tread member 10.

In addition, as shown in FIGS. 2 and 9, in the unvulcanized tire, by disposing wires in the tread member 10 or in the elastomer member disposed inside the tread member 10 in the tire radial direction so that the wires extend along a spiral-like shape which extends along the tire circumferential direction, the electrodes 12a, 12b can be placed so as to extend spirally in the tire after vulcanization. By doing so, the tire including the electrodes 12a, 12b can be manufactured without largely changing a manufacturing method of the tire. Further, by winding the ribbon-shaped elastomer, which has the wires, along the circumference direction, the elastomer member which is used as the tread member 10 in the unvulcanized tire or which is placed inside the tread member 10 in the unvulcanized tire is formed, and thereby it is possible to provide the electrodes 12a, 12b so as to extend spirally in the tire after vulcanization. With this configuration, the electrodes 12a, 12b are efficiently placed in the tire. Also, since the electrodes 12a, 12b are placed inside the tire, the frictional wear or breakage of the electrodes 12a, 12b does not occur easily.

Moreover, the electrical field can be applied more effectively to the elastomer of the tread member 10 because the low permittivity member 12c whose permittivity is lower than that of the elastomer of the tread member 10 are disposed between the pair of electrodes 12a, 12b, which causes a situation in which the electric field goes through the elastomer of the tread member 10 which has a high permittivity, instead of going through the low permittivity member 12c that is located at the shortest way between the electrodes.

In addition, when employing a configuration in which the electrical potentials to the electrodes 12a, 12b are supplied from a power generation element and/or a power storage element which are mounted on the side portion 3 or tread portion 1 of the tire, it becomes possible to eliminate or simplify a configuration for supplying the electrical potentials to the electrodes from the outside of the tire for supplying the electrical potentials to the electrodes 12a, 12b.

As the power generation element, as shown in the Japanese Unexamined Patent Application Publication No. 2008-87512, an elastomer which is attached to the inner circumference surface of a tread portion of a tire and which generates power by repetitive deformation of the tire may be used, a configuration in which the electric power generated by the power generation element is supplied to the electrodes directly can be employed, and a configuration in which the electric power generated by the power generation element is stored in the power storage element, such as a secondary battery or a condenser, so that the electric power is supplied to the electrodes directly from the power storage element.

In this case, when the amount of power generation or the power generation pattern of the elastomer which is attached to the inner circumference surface of the tread portion is used as a sensor for detecting a working condition of the tire, the amount of power generation or the power generation pattern of the elastomer may be used as a detection result of the detection portion 51, and it may also be possible to control an anti-lock braking system or a traction control system based on the amount of power generation or the power generation pattern of the elastomer.

Also, as the power supply unit 60, it may be possible to employ a configuration in which the electrical potentials to the electrodes 12a, 12b is supplied from the power reception portion by attaching the power reception portion of a non-contact power supply system to the tire, and by attaching a power transmission portion of the non-contact power supply system to a vicinity of the tire of a vehicle, such as a tire housing, an axle, a hub, or a wheel. In this case, the electric power is supplied to the power transmission portion from a battery or an in-wheel motor of the vehicle. Moreover, the non-contact power supply system can be configured using a known system such as the electromagnetic induction system, the electromagnetic field resonance system, and the electric wave system. For example, when using the electromagnetic induction system and the electromagnetic field resonance system, a circuit having a coil is formed in the power reception portion, the potential difference occurs between the electrodes 12a, 12b by a configuration in which the electrodes 12a, 12b come into contact with different positions of the circuit. When employing a configuration in which the electricity is supplied from the in-wheel motor, this may be sufficiently utilized for providing the potential difference between the electrodes 12a, 12b since the in-wheel motor is stored in a wheel hub near the tire, and the amount of power generation is large. In order to accumulate the electricity which is generated by the in-wheel motor, the power storage element may be provided at the power transmission portion or the power reception portion.

In addition, coexistence of improvements in both of the grip force and the low fuel consumption can be accomplished in a high level by controlling the potential difference supplied to the electrodes 12a, 12b on the basis of the operation state or the behavior of the vehicle, and by this, the viscoelasticity property of the elastomer which forms the contact surface of the tread member 10 is changed so as to adjust the hysteresis loss near the contact surface of the tread member, which largely affects the grip force and the rolling resistance of the tire.

Further, in this embodiment, as shown in FIG. 4, planar portions 12e, 12f which face the contact surface of the tread member 10 may be provided at the sides extending along axes of the wires which serve as the electrodes 12a, 12b. The planar portions 12e, 12f of the pair of electrodes 12a, 12b mutually define an angle smaller than 180 degrees, preferably, an angle smaller than 170 degrees. With this configuration, the planar portions is capable of applying an electric field to the contact surface of the tread member 10 more efficiently because the electric flux density generated from the planar portions 12e, 12f as the side surfaces of the wires tends to be higher than the electric flux density generated from the different side surface of the wires, and because the planar portions face the contact surface of the tread member 10.

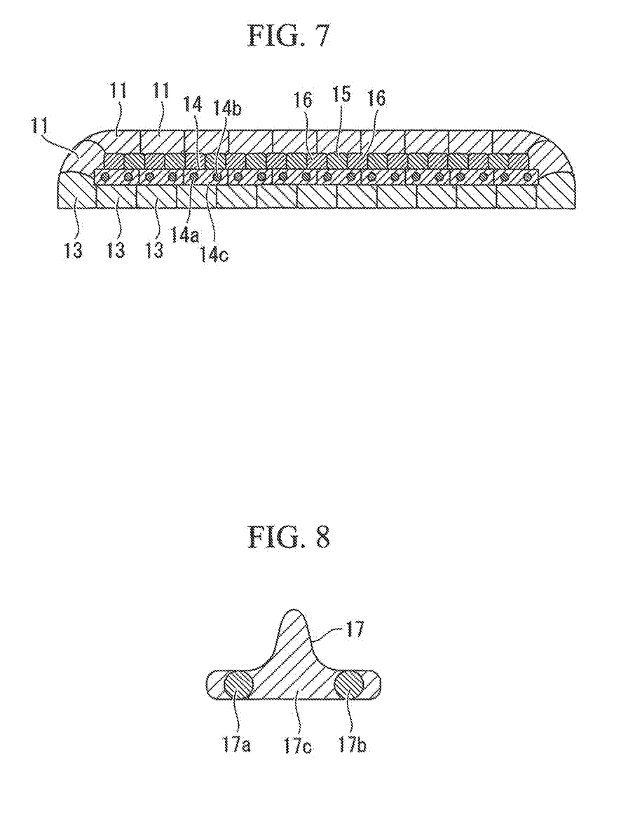

Moreover, in this embodiment, the second ribbon-shaped rubber 12 may be replaced by a second ribbon-shaped rubber 14, a fourth ribbon-shaped rubber 15, and a fifth ribbon-shaped rubber 16 as shown in FIG. 7. In this case, the second ribbon-shaped rubber 14 has an electrodes 14a, 14b and an unvulcanized rubber portion 14c which are the same as or similar to the electrodes 12a, 12b and unvulcanized rubber portion 12d of the second ribbon-shaped rubber of the first embodiment. In this case, it is preferable that the unvulcanized rubber 14c is made of the same materials used in the low permittivity member 12c of the second ribbon-shaped rubber of the first embodiment. The fourth ribbon-shaped rubber 15 is made of the same materials used in the low permittivity member 12c of the second ribbon-shaped member of the first embodiment, and the fifth ribbon-shaped rubber 16 is made of the same materials used in the unvulcanized rubber 12d of the second ribbon-shaped rubber or the first ribbon-shaped rubber 11. The fourth ribbon-shaped rubber 15 and the fifth ribbon-shaped rubber 16 are wound so as to be alternately arranged in the tire width direction, and so that the fourth ribbon-shaped rubber 15 is disposed at the center portion with regard to the pair of electrodes 14a, 14b. This configuration can achieve an effect which is the same as or similar to the effect described above.

Further, in this embodiment, the second ribbon-shaped rubber 12 may be replaced by a second ribbon-shaped rubber 17 as shown in FIG. 8. In this configuration, the second ribbon-shaped rubber 17 has electrodes 17a, 17b which are the same with or similar to the electrodes 12a, 12b of the second ribbon-shaped rubber of the first embodiment. Also, a low permittivity member 17c which support the electrodes 17a, 17b is provided. Also, the low permittivity member 17c has a cross-sectional shape whose central portion protrudes in the tire radial direction in regard to the electrodes 17a, 17b, and the tire radial direction thickness of the positions corresponding to the electrodes 17a, 17b is small. With this configuration, the low permittivity member 17c exists thinly outside in the tire radial direction of the electrodes 17a, 17b, or the low permittivity member 17c does not exists outside in the tire radial direction of the electrodes 17a, 17b. With this configuration, the low permittivity member is arranged between the electrodes 17a, 17b so as to achieve an effect which is the same or similar to the effect described above.

In addition, in a state in which the tire is not vulcanized, a plurality of electrodes may be arranged so as to extend toward one of the side portions 3 via the tread portion 1 from the other side portion 3 by arranging the plurality of wires which extend toward one of the side portions 3 via the tread portion 1 from the other side portion 3 in an elastomer member which is disposed inside the tread member 10 or at a radial inside of the tread member 10. With this configuration, the hysteresis loss near the contact surface of the tread member 10 can be adjusted by applying the electrical field to the tread member 10 so as to change the viscoelasticity of the elastomer which forms the contact surface of the tread member 10.

Also, when the tire has a carcass member and a belt member in which a plurality of reinforcing members which extend to one of the side portions 3 via the tread portion 1 from the other side portion of the tire is provided, by using at least part of the reinforcing members as the wires for the electrodes, the plurality of electrodes can be arranged so as to extend toward one of the side portions 3 via the tread portion 1 from the other side portion 3 in the tire which has been vulcanized. Therefore, the electrodes can be arranged efficiently in the tire. Also, since the electrodes are placed inside the tire, the frictional wear and breakage of the electrodes do not occur easily, which is an advantageous in this article.

Further, the plurality of electrodes can also be arranged so as to extend in the tire radial direction in the tire which has been vulcanized by using wires, as the electrodes, disposed in a strip member which is wound spirally and circumferentially around the outer circumference surface of the belt member or the outer circumference surface of the carcass member.

Also, in this embodiment, although one example applying the electrical field to the contact surface of the tread member 10 is described, for example, it is possible to apply the magnetic field to the contact surface of the tread member 10 by disposing, in the aforementioned embodiments, a magnetic pole member at the position of one of the wires which forms an one of the electrodes, and disposing the other magnetic pole member at the position of the other wire which forms the other electrode. At least one of the magnetic poles is made of an electromagnet. In this case, the viscoelasticity of the elastomer which forms the contact surface of the tread member can be changed, and thereby the hysteresis loss near the contact surface of the tread member can be adjusted.

Also, in the embodiment, when only the vertical grooves 1a are formed on the contact surface of the tread member, and the blocks 1c are continuously formed in the tire radial direction, the pair of electrodes 12a, 12b may be disposed within each of the circumferentially continuing blocks 1c.

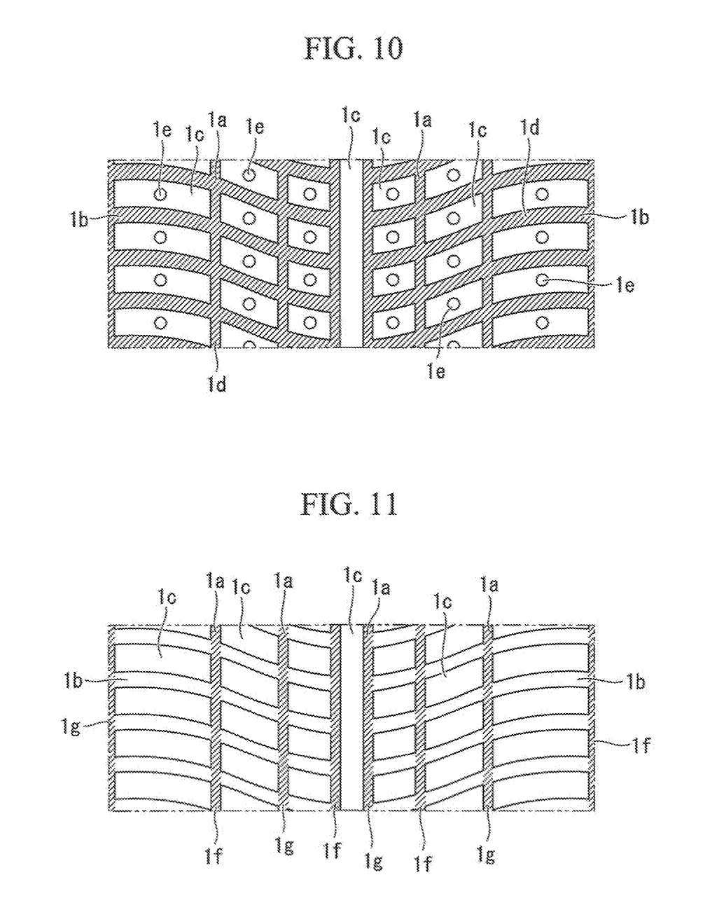

A tire in accordance with a second embodiment of this invention is described below with reference to FIG. 10.

In this embodiment, the configuration of the tread member is changed from that of the first embodiment. Since the remaining configurations are the same as those of the first embodiment, the explanations for those configurations are omitted.

The entire tread member 10 of the second embodiment is made of the elastomer whose viscoelasticity property changes by applying the electrical field or the magnetic field. Alternatively, its contact surface portion is formed by using the elastomer whose viscoelasticity property changes by applying the electrical field or the magnetic field. The method for forming the unvulcanized tire and the vulcanization method is the same as those described in the first embodiment.

In the second embodiment, regarding the vulcanized tire, an electrode 1d is formed on the bottom surfaces of vertical grooves 1a and lateral grooves 1b, and the other electrodes 1e are formed in central portions of blocks 1c. The electrode 1d can be formed by vapor deposition of metal on the bottom surfaces of the vertical grooves 1a and the lateral grooves 1b, or the like. The other electrodes 1e can be formed by embedding metal members in the center portions of the blocks 1c. The electrodes 1d, 1e are connected to the power source via an electric wire passing through a portion which is between the tire constituting members or inside the tire constituting members. On the other hand, when this tire rolls on a rail, it may be possible to employ a configuration in which the electrical potential is applied to one of the electrodes when the tire comes into contact with the rail, by providing the power source to be connected to the rail.

In this case, the hysteresis loss near the contact surface of the tread member 10 can be adjusted by changing the viscoelasticity of the elastomer which forms the contact surface of the tread member 10 by applying the electric field to the contact surface side of the tread member 10.

Moreover, as shown in FIG. 11, electrodes if may be formed by the vapor deposition on the bottom surfaces of part of the plurality of vertical grooves 1a, and the other electrodes 1g may be formed by the vapor deposition on the bottom surfaces of a rest of the vertical grooves 1b. Alternatively, the electrodes may be formed by the vapor deposition on the bottom surfaces of part of the plurality of lateral grooves 1b, and the other electrodes may be formed by the vapor deposition on the bottom surfaces of the rest of the lateral grooves 1b. In this case, the hysteresis loss near the contact surface of the tread member 10 can be adjusted by changing the viscoelasticity of the elastomer which forms the contact surface of the tread member 10 by applying the electric field to the contact surface side of the tread member 10.

In the first and the second embodiment, the tread member 10 is formed by winding a ribbon-shaped rubber. Alternatively, the entire tread member 10 or part of the tread member 10 may be formed by a belt-like member having a width which is the same as or similar to that of the tread portion 1.

Moreover, the configuration of the first and the second embodiment may be used for a tire of an aircraft, and in such case, the same or similar effects can be achieved.

The configuration described in the first embodiment can be employed in a slick tire, and in this case, the same or similar effects can be achieved.

In addition, in the first and the second embodiment, it is possible to maximize the electrical field or the magnetic field applied by the control means 50, or it is possible to make them zero, in response to a detection result detected by a detection means which includes an acceleration sensor and the like to detect emergency breaking of the vehicle by controlling a power supply unit. Therefore, at a time of emergency breaking, by applying the electric field or the magnetic field intensively to the tread portion of the tire, or not applying the electric field or the magnetic field to the tread portion, the maximum grip can be achieved. Further, the electric field or the magnetic field can also be controlled so as to be applied only to a contact area of the tread portion intensively. In this case, it is unnecessary to apply the electric field or the magnetic field to the entire tire, and therefore it is possible to prevent the power supply unit from being larger and it is advantageous with regard to response time for the operation.

These functions may be achieved by using a semi-conductor, a metal, or a polymer, each of which has a pressure switch or a switching function and provided in a wire as an electrode. In other words, a simple and lightweight system can be achieved by integrating the detection means and the power supply unit with the electrode or a conductive wire. As a material of this electrode or conductive wire, it is possible to employ known materials such as a rubber or a plastic to which CNT is dispersed and thereby the electrical resistance can be changed by applying pressure. During regular rotation, such conductive state is cut at the contact portion, and under large stress, such conductive state is realized, by providing such conductive wire in a portion to which pressure and strain caused by contact between the tire and the ground and which is side or tread member, for example, which leads to the above described effect. The conductive state and the non-conductive state due to the surface contact can be reversed, and an opposite result may be obtained by the alternation.

In addition, the electrodes or the magnetic poles may be configured so that an intensity of an electric field or a magnetic field which is applied to a shoulder portions which are disposed in the both end sides of the tire width direction at the tread portion of the tire can be adjusted.

For example, it is possible to configure to apply the electric field to a center side of the tread portion in the tire width direction by using a first pair of electrodes, and to apply the electric field to an end side of the tread member in the tire width direction by using a second pair of electrodes. Since the grip force generated in cornering at a time of general traveling on a dry road surface is sufficient enough, factors that reduction of contact area due to a block rigidity and that sheer strength is important for the purpose of improving a handling performance, and there is another factor that the friction coefficient on icy road is so small that a lateral force becomes small and the strength becomes sufficient enough, and therefore, it is demanded to increase the friction coefficient at low temperature. The above configuration allows to increase the hysteresis friction by controlling the electrodes applied to the shoulder portion depending on conditions. Due to this, for example, a driver can enjoy a satisfactory handling on a way to a ski resort, and a satisfactory grip force can be exerted on a snowy and icy road near the ski resort.

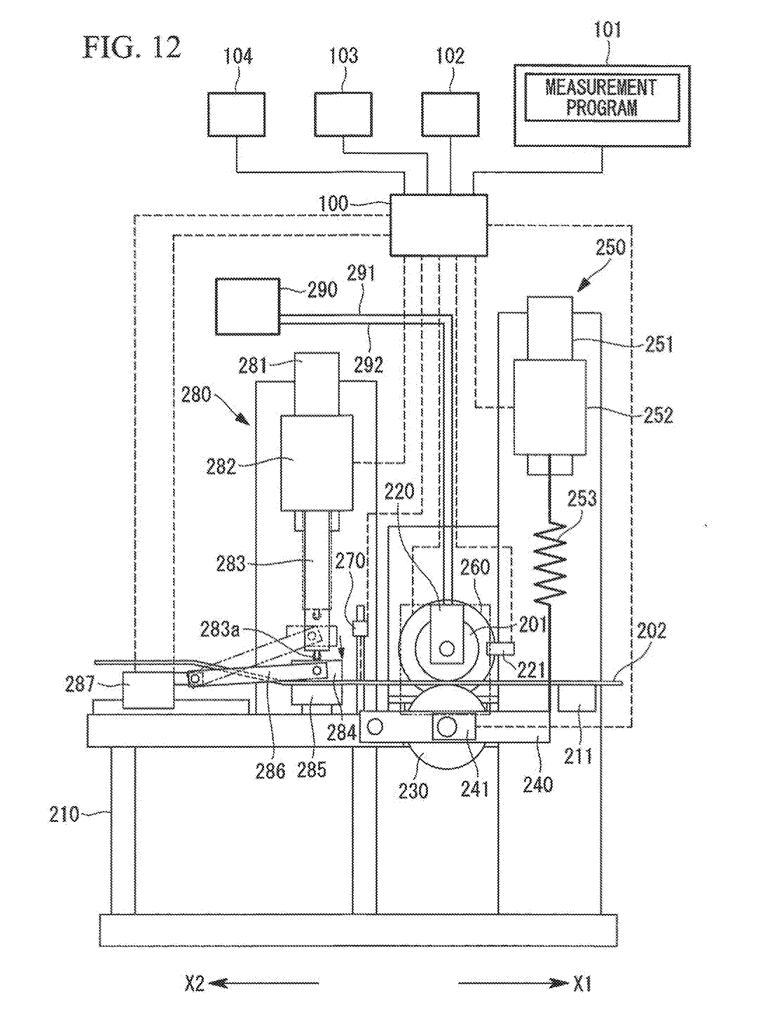

The friction property measurement apparatus according to the third embodiment of the present invention is described below with reference to FIGS. 12 to 17.

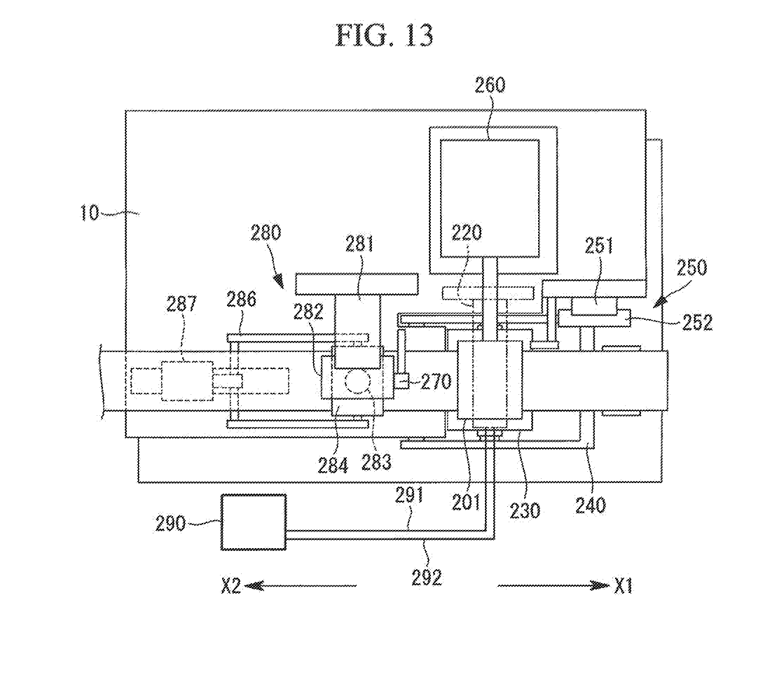

This friction property measurement apparatus comprises, as shown in FIG. 12, a frame 210, a roller support member 220 provided in the frame 210 for rotatably supporting the roller 201, a rotation meter 221 which obtains rotation frequency, rotation speed, and angular acceleration of the outer circumference surface of the roller 201 supported by the roller support member 220 by using a laser Doppler velocimeter or the like, a free roller 230 which is arranged so as to face the roller 201 supported by the roller support member 220 in the radial direction thereof and which holds a sample member 202 between the free roller 230 and the roller 201, a tilting frame 240 one end of which is rotatably coupled to the frame 210 and which rotatably supports the free roller 230, a support mechanism 250 for supporting the other end of the tilting frame 240, a roller driving device 260 mounted on the frame 210 for moving the sample member 202 held between the roller 201 and the free roller 230 toward X1 direction shown in FIGS. 12 and 13 by rotating the roller 201 supported by the roller support member 220, a moving amount measurement device 270 mounted on the frame 210 for measuring moving amount of the sample member 202 in X1 or X2 direction, a resistance force adjusting device 280 which applies resistance force to the sample member 202 in X2 direction shown in FIGS. 12 and 13 and which also adjusts the resistance force, a power supply device 290, and a controller 100 as a measurement controller connected to the rotation meter 221, the support mechanism 250, the roller driving device 260, the moving amount measurement device 270, the resistance force adjusting device 280, and the power supply device 290.

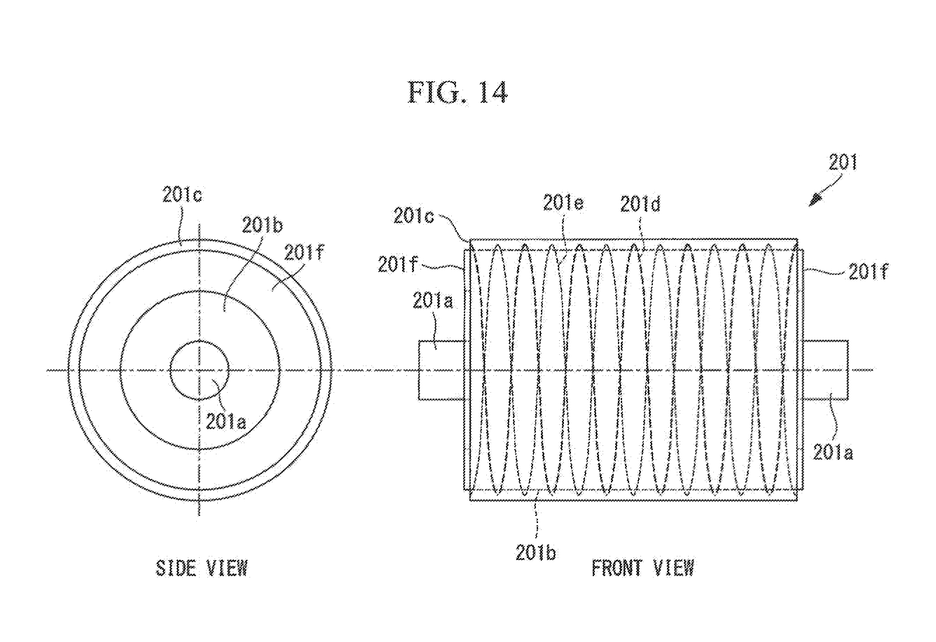

The roller 201, as shown in FIG. 14, has a pair of shafts 201a which is attached to both sides in its axial direction and which is rotatably supported by the roller support member 220, a cylindrical portion 201b which is provided between the shafts 201a, an elastomer portion 201c which is attached to the outer circumference surface of the cylindrical portion by an adhesive agent or the like, and electrodes 201d, 201e which are spirally embedded in the elastomer portion 201c. The both ends of the electrode 201d are respectively connected to a disk-shaped connector portion 201f which is provided at the both ends of the cylindrical portion 201b, and the both ends of the electrode 201e are respectively connected to the shafts 201a. The shafts 201a and the connector portion 201f are insulated.

The elastomer portion 201c is formed by using the elastomer whose viscoelasticity property changes by applying the electric field or the magnetic field. The one described in the first embodiment can be used as such elastomer.

The support mechanism 250 has a rail 251 which is provided so as to extend upwardly from the frame 210, a slider 252 which moves on the rail 251 in the vertical direction by driven by a motor or the like, and an elastic member 253 of a coil spring or the like, whose upper end is supported by the slider 252 and whose lower end is attached to another end of the tilting frame 240 at the same time so as to support the other end. The free roller 230 is rotatably supported between one end and the other end of the tilting frame 240, and by moving the other end of the tilting frame 240 in the upper direction by the support mechanism 250, the free roller 230 also moves upwardly.

The roller driving device 260 has a motor, for example, a servo motor and an oil hydraulic motor. The motor has a rotation portion for rotating the roller, and a clutch which is disposed between a rotation portion and a motor output shaft which switches transmission or non-transmission of a rotation force of the rotation portion to the motor output shaft. Also, the motor has a rotary encoder so that a rotation speed and rotation frequency of the motor output shaft can be monitored on the basis of an output of the rotary encoder.

For a moving amount measurement device 207, a device which can measure a moving amount of the sample member 202 in the X1 direction and X2 direction by using the known laser Doppler velocimeter can be used, the known device which can measure a moving amount of a different kind of sample member 202 in the X1 direction and X2 direction may also be used.

The resistance force adjusting device 280 includes a rail 281 which is provided so as to extend upwardly from the frame 210, a slider 282 which moves on the rail 281 in the vertical direction by driven by a motor or the like, a shaft 283 whose upper end is connected to the slider 282, a contact member 284 which is disposed at the lower end of the shaft 282 downwardly and which comes in contact with another surface (the upper surface in FIG. 12) of the sample member 202, and a pedestal 285 which is disposed so as to face the contact member 284 and which comes in contact with another surface (the lower surface in FIG. 12) of the sample member 202.

With the resistance force adjusting device 280, by moving the slider 282 downwardly, the lower end of the shaft 283 comes in contact with the contact member 284 from above, and at the same time, and the contact member 284 is pushed downwardly so that the sample member 202 gets caught between the lower surface of the contact member 284 and the upper surface of the pedestal 285. By this, a friction resistance force will be applied to the sample member 202 which moves in the X1 direction or X2 direction. The lower surface of the contact member 284 and the upper surface of the pedestal 285 are preferably formed by using a material which has extremely small or no difference between static friction coefficient and kinetic friction coefficient in regard with the sample member 202. For example, a polyacetal composite material (Epocluster T Com 41, etc.) manufactured by Cluster Technology Co., Ltd. may be used for such material.

The resistance force adjusting device further comprises a tilting link 286 as a coupling member, and a load cell 287 which is fixed on a base 210, one end of the titling link 286 is rotatably coupled with the contact member 284 in the vertical direction, another end of the tilting link 286 is rotatably coupled with the load cell 287 in the vertical direction. When the force in the X1 direction is applied to the tilting link 286, the force in the X1 direction is measured by the load cell 287. The slider 282 and the load cell 287 are connected to the controller 100 for this resistance force measurement device 280.

The power supply device 290 includes, a first electrode 291 which is electrically connected to the shafts 201a of the roller 201 which are supported by the roller supported member 20, and a second electrode 292 which is electrically connected to the connector portions 201f of the roller 201. The electrodes 291, 292 are composed so as to maintain the electrical connection even when a roller 1 is rotated by conducting the electrical connection between the shafts 201a and the connector portions 220 when the roller 201 is supported on the roller support member 220.

The controller 100 has the known computer, and the controller 100 has a memory 201 which stores a measurement program for conducting the friction property measurement by operating this device, an input unit 102, a display device 103, and a printer 104. As commanded by the measurement program, the controller 100 controls the support mechanism 250, the roller driving device 260, resistance force adjusting device 280, and the power supply device 290, and this program is configured so as to conduct the friction property measurement. An example of a method for conducting the friction property measurement by using this device is described below.

First, prepare the roller 201. The shafts 201a of the roller 201 are supported by the roller support member 220 so that the roller 201 is rotatably supported by the roller support member 220 (step 1), by this, an electrical connection is made between the shafts 201a and the connector portion 201f of the roller 201 with the electrodes 291, 292 of the power supply device. Also, one of the shafts 201a of the roller 201 is coupled with the motor output shaft of the roller driving device 260.

Also, the sample member 202 is disposed on the free roller 230, the pedestal 285 of the resistance force adjusting device 280, and an auxiliary table 211 which is provided at the right side of the free roller 230 as shown in FIG. 12 (step 2), in accordance with FIG. 12, the one end side of the tilting link 286 is tilted from a position shown in two-dot chain line to a position shown in solid line, also the shaft is moved downwardly so that the sample member 202 gets caught between the lower surface of the contact member 284 and the upper surface of the pedestal 285 (step 3). The sample member 202 may be changed on the basis of a purpose of sampling, and when the friction property is measured in order to develop a sheet feeding roller, a sheet used by the sheet feeding roller may be the sample member 202, when the friction property is measured in order to develop a tread rubber for tire, a sheet-like member which has a friction property corresponding to a road surface may be used as the sample member 202.

In addition, the contact member 284 is pressed against the pedestal 285 by the slider 282 (step 4). Yet, the slider 282 has the load cell for measuring the pressing force, and a spring is provided at a portion which is between the slider 282 and the shaft 283 so that the pressing force does not vary even when an interval between the contact member 284 and the pedestal 285 changes by roughness of the sample member 202, or the like while measuring the friction property. The controller 100 controls the pressing force of the slider 282 by monitoring a detection result of the load cell, therefore, the pressing force which presses the contact member 284 against the pedestal 285 can exactly be adjusted.

Further, the outer circumference surface of the roller 201 is pressed against the sample member 202 which is disposed on the free roller 230 by moving the slider 252 of the support mechanism 250 upwardly (step 5). The controller 100 controls the pressing force of the slider 252 by monitoring a measurement result of a pressing force measurement device 241, also, the slider 252 is connected to another side of the tilting frame 240 via the elastic member 253 so that the pressing force against the sample member 202 of the roller 201 can exactly be adjusted. The controller 100 includes the elastic member 253 so that the pressing force against the sample member 202 of the roller 201 can be prevented from being changed largely even when an interval between the roller 201 and the free roller 230 varies to a certain extent due to a roughness of the roller 201 and the sample member 202, or the like while measuring the friction property.

Also, an example of a friction property measurement which is conducted by changing the property of the outer circumference surface of the roller 201 while applying the resistance force in the X2 direction to the sample member 202 is described. The below describes an operation of the controller 100 operated by the measurement program. Firstly, when conducting this measurement, the pressing force which presses the outer circumference surface of the roller 201 against the sample member 202 by the support mechanism 250 needs to be a constant value (measurement step 1-1). Also, the pressing force of the slider 282 is maintained to be a constant value by the support mechanism 250 so as to apply a constant resistance force (measurement step 1-2). In addition, the below may be carried out by changing the pressing force or the resistance force. Further, an electrical potential is supplied to the electrodes 291, 292 by the power supply device 290, and a constant electrical potential difference is provided between the electrodes 201d, 201e of the roller 201.

In addition, ensure the clutch is in a transmission state in a predetermined period when the rotation portion is rotated at a certain rotation frequency while the clutch of the motor of the roller driving device 260 is in a non-transmission state (measurement step 1-3). By this, the roller 201 instantly starts to rotate at the certain rotation frequency, and keeps the rotation for the predetermined time. When an inertial mass of the rotation portion of the motor of the roller driving device 260 in a rotation direction is sufficiently larger than the roller 201, the rotation speed of the roller 201 corresponds with the rotation portion in the non-transmission states soon and becomes stable. The sample member 202 is moved in the X1 direction by this rotation of the roller 201, and the moving amount thereof is measured by the moving amount measurement device 270.

Further, a moving amount of the sample member 202 during the predetermined time is received from the moving amount measurement device 270 (measurement step 1-4), also, by using at least a moving amount in a certain period among the predetermined time (the first 0.something second of the predetermined time, a few seconds after a few seconds elapsed since the predetermined time, entire period of the predetermined time, and etc.), the pressing force of the support mechanism 250 during the predetermined time, the resistance force of the resistance force adjustment device 280 during the predetermined time, and the potential difference between the electrodes 201d and 201c are correlated so as to derive the friction property from this measurement (measurement step 1-5).

Here, the controller 100 receives a force in the X1 direction applied to the tilting link 286 from the load cell 287 of the resistance force adjustment device 280, and a resistance force applied to the sample member 202 is derived by the resistance force adjustment device 280 on the basis of the received force in the X1 direction. For example, in this embodiment, the lower surface of the contact member 284 and the upper surface of the pedestal 285 are made of a same material, and, the lower end of a shaft 83 comes in contact with a contact member 84 via a bearing 283a which is fixed to the lower end of the shaft 283, wherein the bearing 83a is rotatable in the X1 and X2 directions, a contact resistance between the lower end of the shaft 83 and the contact member 84 in the X1 direction is so small that it can be ignored, therefore, a force which doubles the force in the X1 direction received from the load cell 287 can be the resistance force.

Moreover, while changing the potential difference established between the electrodes 201d, 201c, repeatedly conduct the measurement steps 1-3 to 1-5 for more than once (measurement step 1-6). Further, while changing a condition of the pressing force, a condition of the resistance force, the rotation speed of the roller 201, and the like, repeatedly conduct the measurement steps 1-3 to 1-5 for more than once (measurement step 1-7).

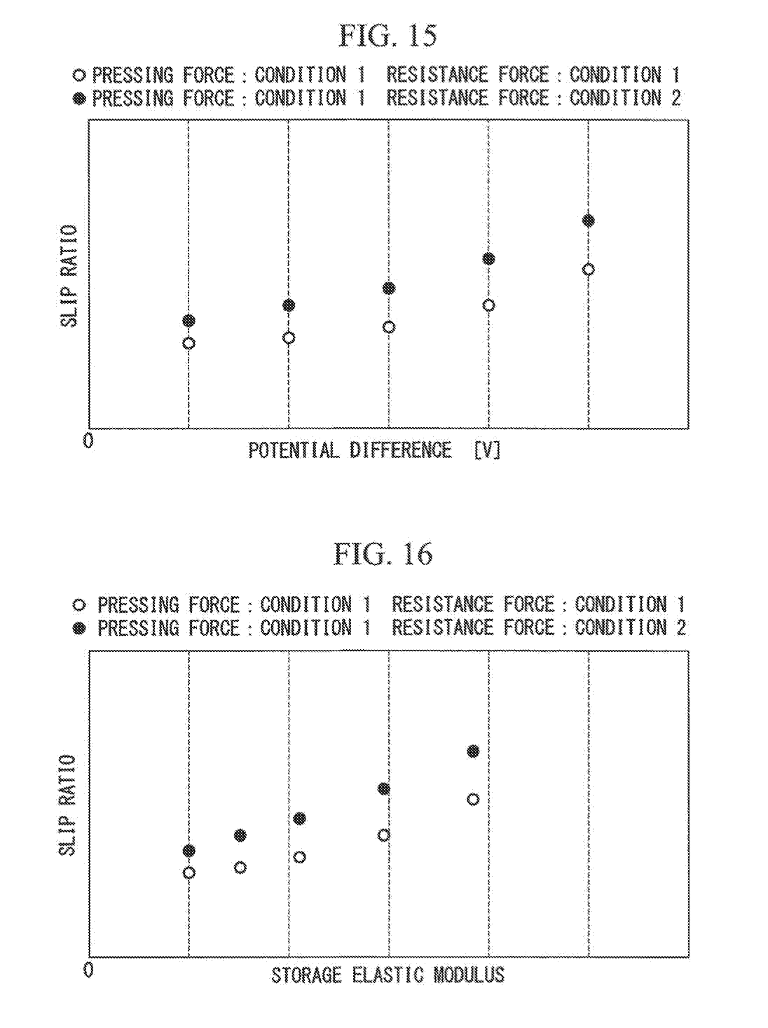

For example, a result shown in the FIG. 15 can be obtained by conducting the above while changing the condition of the resistance force (the pressing force which presses the contact member 284 against the pedestal by the slider 282) in step 1-7.

A vertical axis shown in FIG. 15 shows a slip ratio SL (SL=(L0−L)/L0. L0 represents an ideal moving amount of the outer circumference surface of the roller 201 calculated by multiplying a rotation angle which is received from the rotation meter 221 in the predetermined period, a roller diameter, and the circular constant. L represents the moving amount of the sample member 202 in the predetermined period.), a horizontal axis represents the potential difference between the electrodes 201d, 201e. In order to evaluate the slip ration, measurement points in FIG. 16 respectively associate the pressing force, the resistance force, and the potential difference between the electrodes 201d, 201e on the basis of the moving amount of the sample member 202 and the moving amount of the outer circumference surface of the roller 201. For example, if a measurement result becomes like the one shown in FIG. 15, the slip ratio becomes larger as the potential difference gets larger. Also, the measurement result is not limited to become like FIGS. 15, 16, 17, 19, 20, it is in response to a material of the elastomer portion 201c, a material of the sample member 202, or a measurement condition. The slip ratio is one example of the friction property derived by using the moving amount of the sample member 202 and the moving amount of the outer circumference surface of the roller 201, alternatively, it is also possible to evaluate a coefficient of the friction property by using the moving amount of the sample member 202 and the moving amount, the pressing force, and the resistance force of the outer circumference surface of the roller 201, it is further possible to evaluate a coefficient of the friction property by using a width dimension of the sample member 202, also, it is possible to evaluate a coefficient of a different kind of friction property by using the moving amount of the sample member 202 and the moving amount of the outer circumference surface of the roller 201.

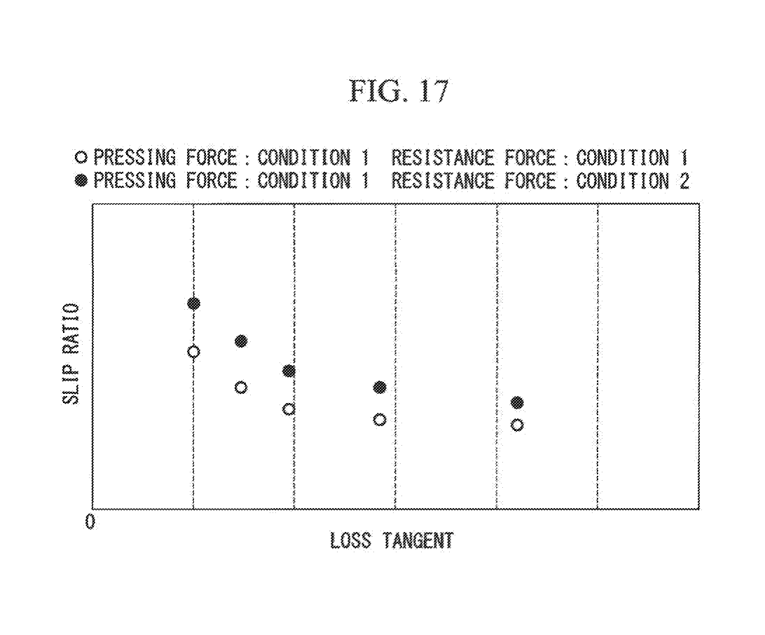

In this configuration, a memory 101 of the controller 100 stores the potential difference which is provided between the electrodes 201d, 201e by the power supply device 290, and a table which is associated with the viscoelasticity of the elastomer which forms the elastomer portion 201c of the roller. For example, it stores storage elastic modulus, loss elastic modulus, loss tangent and the like which is in response to the potential difference. The controller 100 exchanges the result shown in FIG. 15 into the ones shown in FIGS. 16 and 17 with reference to the table. By this, relationship between the viscoelasticity property and the friction property of the elastomer can be obtained without taking time and effort.

Also, the measurement program is operated so that the controller 100 shows the measurement results of FIGS. 15 to 17 on the display device 103, outputs the measurement results to the printer 104, and stores the measurement results of FIGS. 15 to 17 to the memory 101. The measurement results may be output to different kinds of computers instead of the printer 104. Like this, the controller 100 displays the friction property (slip ration or the like) on the display device 103, outputs, and stores it by corresponding with the pressing force and the resistance force, and, by corresponding with the potential difference between the electrodes 201d, 201e or the viscoelasticity property of the elastomer of the outer circumference surface of the roller 201.

Here, a state where the slip ratio SL becomes 1 (100%) is a state where the roller 201 and the sample member 202 slides completely, therefore, a ratio of the resistance force and the pressing force in this state is the same or close to an ordinary friction coefficient. On the other hand, by adjusting the pressing force and the resistance force, the above described measurement can measure the slip ratio of greater than 0% and less than 100%, for example, a range in vicinity of 5%, 10%, 30%, 50%, and the like, however, a condition where slight slipping occurs is the approximate or the same condition with the one using the sheet feeding roller, the tire, or the like on the actual machine.

In addition, in this embodiment, the friction property is derived by changing the elastomer property of the outer circumference surface of the roller 201 by applying the electric field. On this account, understanding and consideration or the optimization of the electric field and a parameter for controlling magnetic field of this elastomer under a requirement of the actual machine. Also, it can be used for other usage in some cases, for example, it is possible to obtain a relationship between the friction property which is developed on the actual machine and a property of a material of the elastomer alone, or an intended property (solidity, viscoelasticity property or the like) of the material of the elastomer alone without recovering the elastomer of the outer circumference surface of the roller 201 or exchanging the roller 201 itself. This is applicable to different embodiments described below.

Further, as well as the pressing force applied to the sample member 202, it is possible to obtain a change in the friction property against the resistance force which is applied to the sample member 202, it is further possible to obtain a change in the friction property against a condition of the applied magnetic field, therefore, for example, it is possible to spuriously measure the friction property which occurs on the actual machine by corresponding an acceleration of a vehicle with a size of the resistance force, corresponding a weight of the vehicle with the pressing force, and corresponding the viscoelasticity property of the tread rubber of the tire with the condition of the magnetic field. Also, for example, it is possible to spuriously measure the friction property which occurs on the actual machine by corresponding a force which is applied to a paper which is fed by the sheet feeding roller in a paper face direction with a size of the resistance force, corresponding a nip force of the paper with the pressing force, and corresponding the viscoelasticity property of the elastomer of the outer circumference surface of the sheet feeding roller with the condition of the magnetic field.

Also, the friction property is derived by changing the condition of the applied magnetic field for several time by the controller 100, therefore, it is possible to obtain a relationship between the condition of the magnetic field and the friction property, and it is possible to see a trend which is generated between the magnetic field and the friction property.

In addition, in the above embodiment, the friction property is measured by applying the resistance force, however, the friction property, such as the slip ratio SL or the like, can be measured without applying the resistance force, and in such case, it is possible to confirm an accuracy of a carrying distance on the sample member 202 when the roller 201 rolls thereon in a state where only the pressure force is applied.

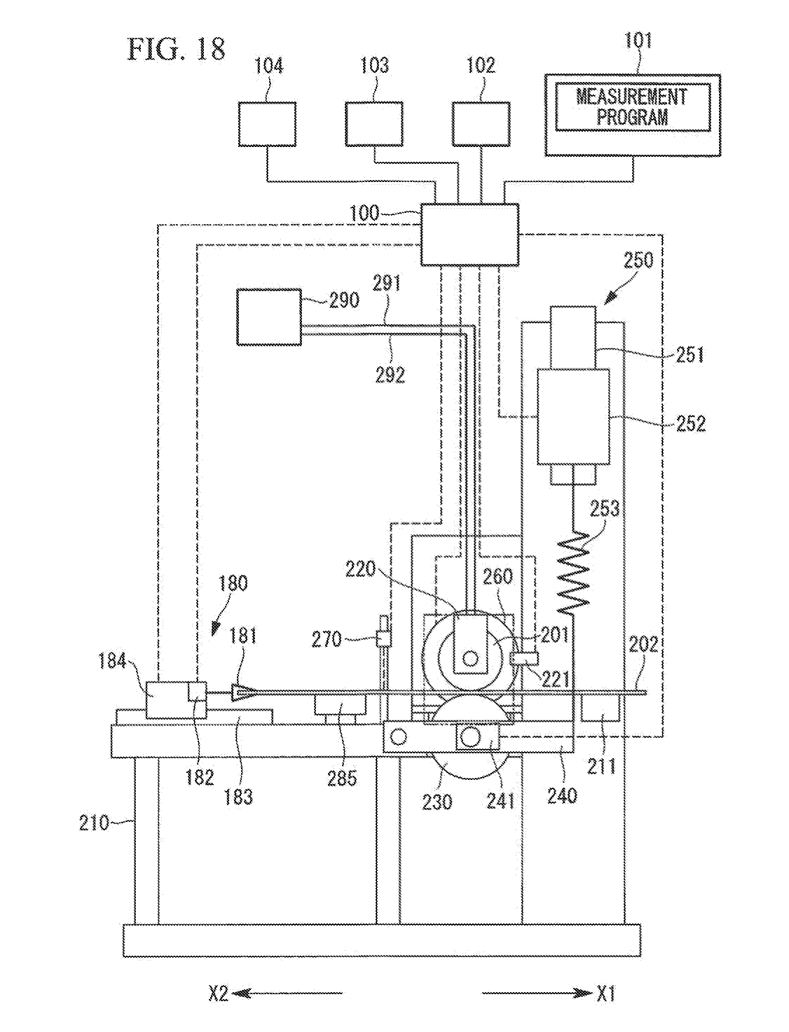

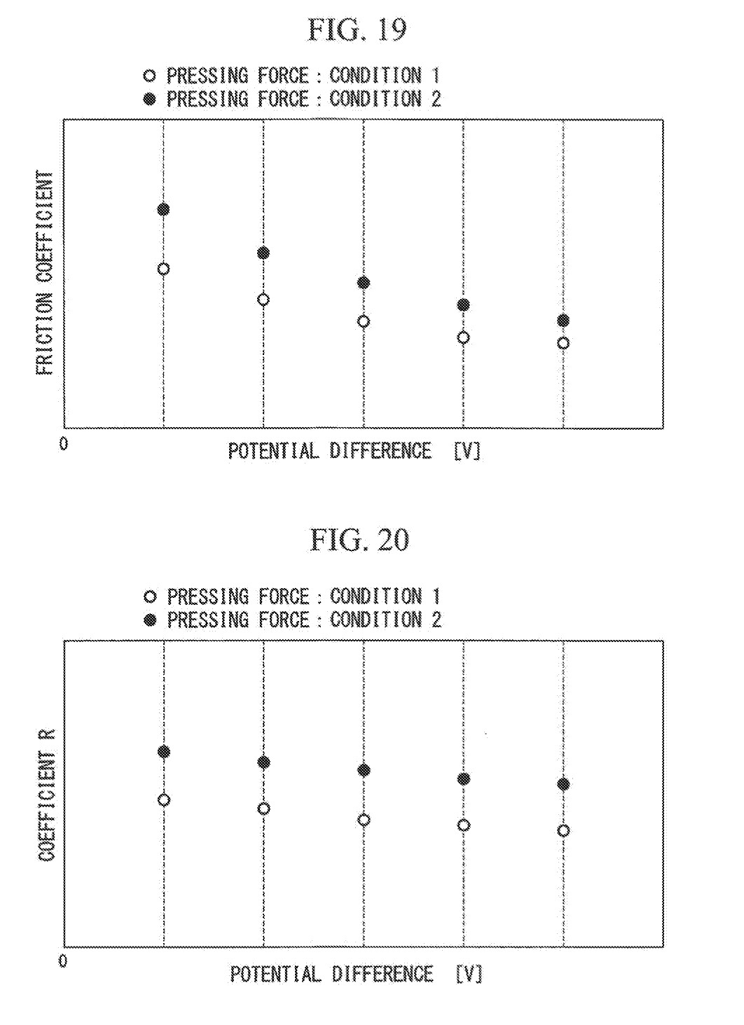

The friction property measurement apparatus in accordance with a forth embodiment of the present invention is described below with reference to FIGS. 18 and 19.

As shown in FIG. 18, when comparing it with the apparatus of the third embodiment the device, in this embodiment, the resistance force adjustment device 280 is replaced by a loading device 180, and it differs in a point that the friction property is measured in a state that the roller 201 and the sample member 202 slide completely, however, the other structures are the same. Only the difference from the third embodiment will be described.

The loading device 180 comprises a clip 181 which is fixed to one end of the sample member 202 in a lengthwise direction and which is caught between the roller 201 and the free roller 230, a load cell 182 which is connected to the clip 181 via a flexible member such as a strap, and a slider 184 which moves toward the sample member 202 in the lengthwise direction on the rail 183 by driven by a motor or the like. The load cell 182 and the slider 184 of the loading device 180 are connected to the controller 100. Also, the device in the first embodiment can mount the resistance force adjustment device 280 and the loading device 180 selectively.

With the device, the below describes one example of the friction property measurement conducted by changing a property of the outer circumference surface of the roller 201 in a state that the roller 201 and the sample member 202 slide completely. The below is conducted when the steps 1, 2, and 5 in the first embodiment are completed. Also, an operation of the controller 100 as commanded by the measurement program is described below.

First, when conducting this measurement, the pressing force pressed the outer circumference surface of the roller 201 against the sample member 202 by the support mechanism 250 should be kept at a certain value (measurement step 2-1). Also, the below may be conducted by changing the pressing force. Further, a certain potential difference is provided between the electrodes 201d, 201e of the roller by supplying an electrical potential respectively to the electrodes 291, 292 by the power supply device 290.

Next, the roller 201 is fixed to the rotation direction by fixing the motor output shaft by using the roller driving device 260 (measurement step 2-2). The shaft 201a of the roller 201 may be fixed to the frame 210 via a different kind of special jig so that the roller 201 can be fixed to the rotation direction. In this state, by moving the slider 184 of the loading device 180 in the X2 direction at a predetermined speed or a predetermined speed profile in a predetermined period (measurement step 2-3), it is possible to measure a force which is applied to the sample member 202 in the X2 direction at the time of moving by the load cell 182.

Further, a force in the X2 direction in the predetermined period is received from the load cell 182 (measurement step 2-4), also, the friction property is derived from the measurement by using at least a force in a certain period among the predetermined time (the first 0.something second of the predetermined time, a few seconds after a few seconds elapsed since the predetermined time, entire period of the predetermined time or the like.) and the pressing force which presses the outer circumference surface of the roller 201 against the sample member 202, and corresponding the pressing force or the potential difference generated between the electrodes 201d, 201e (measurement step 2-5).

And, while changing the potential difference given between the electrodes 201d, 201e, repeatedly conduct the measurement steps 2-3 to 2-5 for more than once (measurement step 2-6). Further, while changing the condition of the pressing force, repeatedly conduct the measurement steps 2-1 to 2-6 for more than once (measurement step 2-7). By conducting such measurement, it is possible to obtain a result shown in FIG. 19, for example.

A vertical axis shown in FIG. 19 shows a friction coefficientμ (μ=measurement value of the load cell 182/pressing force), a horizontal axis shows the potential difference between the electrodes 201d, 201e. In FIG. 19, the friction coefficient is calculated by associating the potential difference between the electrodes 201d, 201e and the pressing force according to the measurement value and the pressing force of the load cell 182. For example, when the measurement result becomes like the one shown in FIG. 19, it can be seen that as the potential difference becomes bigger, the friction coefficient gets smaller. The friction coefficient is an example of the friction property which is derived by using the measurement value and the pressing force of the load cell 182, further, it may be possible to use a contact area of the roller 201 and the sample member 202, and it may also possible to calculate a different kind of coefficient of the friction property by the measurement value and the pressing force of the load cell 182.

And, similar to the third embodiment, the result shown in FIG. 19 can be presented as a result which corresponds the loss elastic modulus, the loss tangent or the like in the same way as the one shown in FIGS. 16 and 17 of the third embodiment with reference to the table stored in the memory 101. By this, it is possible to obtain a relationship between the viscoelasticity property and the friction property of the elastomer without taking time and effort.

In this embodiment, the friction property can be derived by at least using a force which is measured by the load cell and the pressing force, therefore, for example, the friction property is closely similar to the one which occurs on the actual machine by breaking of the functional parts such as a tire or the like while generating slipping between the road surface and the functional part. On this account, understanding and consideration or the optimization of the electric field and a parameter for controlling magnetic field of this elastomer under a requirement of the actual machine.

An effects obtained by measuring the friction property while changing the applied condition of the electric field, the pressing force or the like is the same as the one in the third embodiment.

Further, in the present embodiment, the sample member 202 is moved in the X2 direction while fixing the roller to the rotation direction, however, it may be possible to calculate the friction coefficient on the basis of the measurement value and the pressing force of the load cell 182 of a moment when forcing the roller 201 to rotate while fixing the slider 184 so that the friction force becomes effective to the sample member 202 in the X2 direction regarding the outer circumference surface of the roller 201.

The friction property measurement apparatus of the fifth embodiment of the present invention is described below.

In this present embodiment, with the device of the third embodiment, the friction property measurement is conducted without applying the resistance force. Also, the roller driving device 260 is composed so that a driving torque which drives the roller 201 can be detected. With the device of the third embodiment, one example of the friction property measurement conducted by changing the property of the outer circumference surface of the roller 201 by changing the property of the elastomer portion 204b of the sample member 202 without applying the resistance force to the sample member 202 in the X2 direction is described below. The operation of the controller 100 as commanded by the measurement program is described below.

This measurement is conducted at a state where the steps 1, 2, and 5 are completed, and the contact member 284 and the pedestal 285 are alienated with each other.

Firstly, the pressing force pressed the outer circumference surface of the roller 201 against the sample member 202 by the support mechanism 250 is maintained to be a constant value (measurement step 3-1). In addition, the below may be carried out by varying the pressing force. Further, a potential is supplied to the electrodes 291, 292 by the power supply device 290, and a constant potential difference is provided between the electrodes 201d, 201e of the roller 201.

In addition, ensure the clutch is in a transmission state in a predetermined period when the rotation portion is rotated at a certain rotation frequency while the clutch of the motor of the roller driving device 260 is in a non-transmission state (measurement step 3-2). By this, the roller 201 instantly starts to rotate at the certain rotation frequency, and keeps the rotation for the predetermined time. With the rotation of the roller 201, a rotation torque of the roller 201 is measured by the roller driving device 260 when the sample member 202 is moved to the X1 direction.

Moreover, the rotation torque of the roller 201 in the predetermined period is received from the roller driving device 260 (measurement step 3-3), also, it is possible to derive the friction property from this measurement by using at least the rotation torque in a certain period among the predetermined time (the first 0.something second of the predetermined time, a few seconds after a few seconds elapsed since the predetermined time, entire period of the predetermined time, and etc.), correlating the pressing force of the support mechanism 250 in the predetermined period and the potential difference between the electrodes 201d, 201e (measurement step 3-4).

Moreover, while changing the potential difference provided between the electrodes 201d and 201c, repeatedly conduct the measurement steps 3-2 to 3-4 for more than once (measurement step 3-5). Further, while changing the condition of the pressing force of the measurement step 3-1 to 3-5, repeatedly conduct the measurement steps 3-1 to 3-5 for more than once (measurement step 3-6) so that the result shown in the FIG. 20 can be obtained.

The vertical axis shows a coefficient R (R=rotation torque/pressing force) with regard to the rolling resistance, the horizontal axis shows the potential difference between the electrodes 201d, 201e respectively.

For example, if the measurement result becomes like the one shown in the FIG. 20, it can be understood that the coefficient R with regard to the rotary resistance becomes smaller as the potential difference becomes bigger. The controller 100 exchanges the result shown in FIG. 20 into the ones shown in FIGS. 16 and 17. By this, it becomes possible to obtain the relationship between the viscoelasticity property and the friction property of the elastomer without taking time and effort.

In this manner, in the present embodiment, the friction property is derived by using at least the rotation torque and the pressing force, therefore, for example, it is possible to obtain a friction resistance (which effects the rotary resistance) which occurs when positions of the outer circumference surface of the tire comes in contact with the road surface for every one revolution of the tire. On this account, understanding and consideration or the optimization of the electric field and a parameter for controlling magnetic field of this elastomer under a requirement of the actual machine.

An effects obtained by measuring the friction property while changing the applied condition of the electric field, the pressing force or the like is the same as the one in the third embodiment.

Also, in the embodiments described above, it may be configurable that a pedestal is placed instead of the free roller, and the sample member is placed on the upper surface of the pedestal, and the sample member is pressed against the pedestal by the roller 201. In this case, the resistance force in the X2 direction may be applied to the sample member by the friction force which operates between the pedestal and the sample member.

Further, the above embodiment uses the roller 201 attaching the elastomer 201c on the outer circumference surface. Whereas, the roller 201 can also be formed by using a tire or a fractional sized imitation tire, and a wheel part on which a bead member of this tire is mounted. In this case, it may be possible to fill air in the tire. Also, in the above embodiment, it is further possible to attach the elastomer portion 201c on which grooves or blocks which are equivalent to the tread pattern are formed to the outer circumference surface of the roller 201.

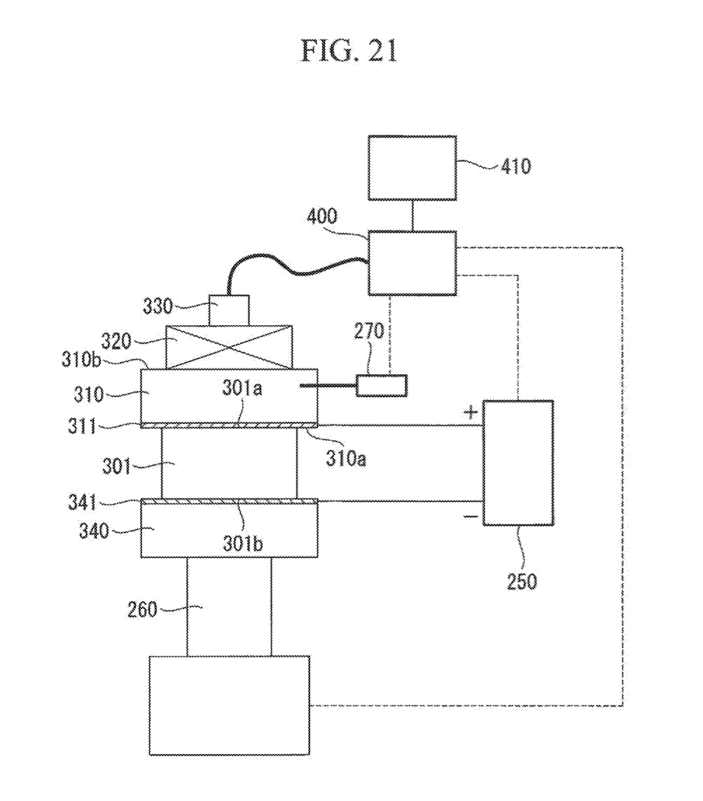

The viscoelasticity property measurement device regarding the sixth embodiment of this invention is described below with reference to FIGS. 21 to 24.

This viscoelasticity property measurement device is a device for measuring the viscoelasticity property of a measuring object. The viscoelasticity property in this embodiment is a general term used for a property which is regulated by one or a plurality of the storage elastic modulus, loss elastic modulus, and loss tangent when sonic wave is radiated.

This viscoelasticity property measurement device has a delay member 310 whose surface contacts with a first surface 301a of the measuring object 301, a transducer whose surface contacts with an incident surface 310b which is opposed to a contact surface 310a which contacts the first surface 301a on the delay member 301, a transmission/reception circuit 330 which accompanies the transducer 320, and a lower surface member 340 whose surface contacts a second surface 301b which is disposed so as to face the first surface 301a on the measuring object. On the contact surface 310a of the delay member 310, a first sheet-like electrode 311 which extends along the whole surface thereof is formed, and on the contact surface which comes in contact with the measuring object 301 of the lower surface member 340, a second sheet-like electrode 341 which extends along the whole surface thereof is formed.

This device includes a voltage application device 350 which is connected to the electrode 311, 341 respectively, a lifting device which is formed by using an electric cylinder or the like so that the delay member 310 and the lower surface member 340 surface contact with the measurement object 301 by lifting the lower surface member 340, and a thermometer for measuring temperature of the delay member 310, and this device is connected to the transducer 320 via the transmission/reception circuit 330, and comprises a measurement controller 400 which is formed by using the known computer which is connected to the voltage application device 350, the lifting device 360, and the thermometer 370, and a display device 410 such as the known liquid crystal display or the like, which is connected to the measurement controller 400. The measurement controller 400 controls the transducer 320 which includes the transmission/reception circuit 330, the voltage application device 350, and the lifting device 360, and the measurement controller 400 stores the measuring program so that the viscoelasticity property is derived according to data (data of temporal intensity variation) of an incident wave which is received from the transmission/reception circuit 330, a reference reflection wave, a first reflection wave, and a second reflection wave.

The measuring object 301 is made of the elastomer whose viscoelasticity property changes by applying the electric field or the magnetic field. The one shown in the first embodiment may be used as such elastomer.

The delay member 310 is made of a material (such as glass, acrylic or the like) which can propagate the sonic wave, the transducer 320 is mounted on its upper surface.

The transducer 320 is made of a piezoelectric element such as lead zirconate titanate and the like, and it radiates the sonic wave to the incident surface 310b of the delay member 310. Also, the transducer 320 receives the first reflection wave which reflects the incident wave which radiates the delay member 310 at a position where the contacts surface 310a of the delay member 310 comes in contact with the first surface 301a of the measurement object 301, and the second reflection wave which reflects the incident wave at a position where the second surface 301b of the measurement object 301 comes in contact with the lower member 340. It is applicable to any frequency of the sonic wave which radiates the delay member 310 from the transducer 320, but high frequency of 1000 Hz or more is preferable, and the frequency above the audible band, for example, ultrasonic wave of 20000 Hz or more is more preferable.

The transmission/reception circuit 330 controls the sonic wave radiates the delay member 310 from the transducer 230 in response to an instruction from the measurement controller 400, and at the same time, it outputs information of the reflection wave, and information of the reference reflection wave received by the transducer 320, the first reflection wave, and the second reflection wave to the measurement controller 400.

The lifting device 360 includes the load cell inside thereof, and the load cell which detects a force applied to the measuring object 301 in the vertical direction.

The voltage application device 350 is configured so as to apply any voltage to a portion which is between the electrodes 311, 341 in response to an instruction from the measurement controller 400.

In FIG. 21, in order to understand the structure of this embodiment, the second electrode 341 is shown thicker than it should be, however, actually, a thin metallic film within a few μm to a several dozen μm may be used as the electrode, or, suitable reflection property may be given to the lower surface member 320 so as to serve as a metallic conductor. In addition, the first electrode 311 may be the thin metallic film as described above, and is formed by using the known conductive resin material or the conductive elastomer so that the thin metallic film may be the same or equal to that of an acoustic impedance of a material which is used for forming the delay member 310. Or, it may also be possible that the delay member 310 itself to act as an electrode whose surface contacts with the first surface 301a of the measuring object 301 by the entire delay member 310 which serves as a conductor.

To compensate an effect of temperature of the viscoelasticity property, this device measures the temperature of the delay member 310 by using the thermometer 370. Also, the measurement controller 400 stores, per a temperature of the delay member 310, a plurality of a reference data showing a property of the reference reflection wave of which reflection wave is reflected and measured at a point of the contact surface 310a of the delay member 310 to a data memory portion 402 in advance by making corresponding to a temperature of the delay member 310 at a state that a reference medium (air as one example) is being contacted to the contacting surface 310a of the delay member 310 (referred as “reference state” hereinafter) without the measuring object 301 contacting to the contacting surface 310a (for example, the data is stored before step 4-1 which will be described below).

As discussed later, a temporal intensity variation property of the reference reflection wave, an amplitude property and a phase property within respective frequency sections of the reference reflection wave are included as the reference data. And, at a beginning of the measurement, the measurement controller 400 determines a corrected reference data in response to a temperature measurement value of the delay member 310 which is measured by the thermometer 370 on the basis of the reference data per temperature which is stored in advance. As an example, the measurement controller 400 calculates the viscoelasticity property of the measuring object 301 from an obtained measurement signal in a measuring state by making the determined corrected reference data as the standard.

In this manner, the measurement controller 400 determines a reference data suitable for the temperature of the delay member 30 at the time of measurement among a plurality of the reference data obtained in advance in correspondence to the temperature of the delay member 310, and calculates the viscoelasticity on the basis of the determined reference data. As a result, it is possible to control an influence on the measurement result of the viscoelasticity, which is caused by a temperature change of the delay member 310.

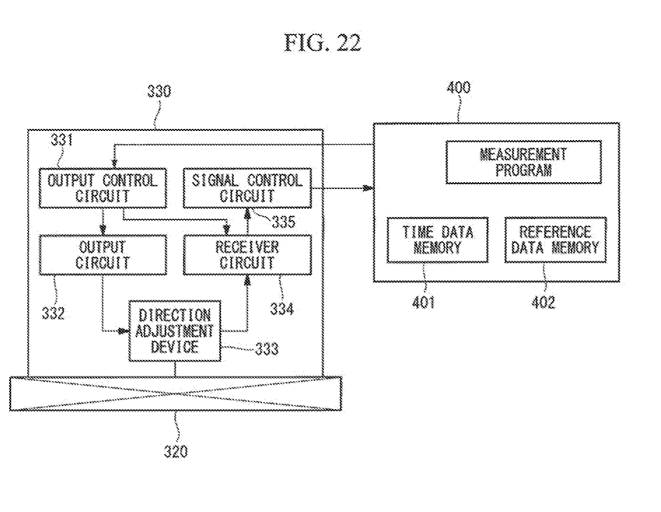

As shown in FIG. 22, the measurement controller 400 includes a time data memory 401 and a reference data memory 402, the time data memory 401 stores the temporal intensity variation of the reflection wave received by the transducer 320. The reference data memory 402 stores a plurality of the reference data which shows a property of the reference reflection wave by corresponding a temperature of the delay member 310.

In addition, the measurement controller 400 is operated by a measurement program, and after receiving a measurement start instruction from a user or the like, the corrected reference data which corresponds with the temperature measured value is determined on the basis of the reference data respective temperature of the delay member which is stored in the reference data memory 402 by obtaining the temperature measure value of the delay member 310 from the thermometer 370. Further, the measurement controller 400 gives radiation order to the transmission/reception circuit 330 so as to radiate the incident wave from the transducer 320 and to temporarily store the reflection data wave received by the transducer 320 in the time data memory 401. Moreover, the measurement controller 400 calculates the viscoelasticity of the measuring object 301 on the basis of data stored in the time data memory 401 and the reference data memory 402. Also, in the calculation process of the viscoelasticity of the measuring object, the measurement controller 400 conducts frequency analysis processing such as Fast Fourier Transform (FFT) on both of the reference data and the measurement data, and after obtaining amplitude property and the phase property in the respective frequency sections, the measurement controller 400 calculates the viscoelasticity property on the basis of the obtained amplitude property and the phase property in the respective frequency sections.

With the above-described device, a method for measuring the viscoelasticity of the measuring object 301 is described below.

Firstly, when the measuring object 301 which is formed in a predetermined size is placed on the lower surface member 340, and the measurement start instruction to the measurement controller 400 is input, the measurement controller 400 accepts the instruction, the measurement controller 400 controls the lifting device 360 as commanded by the measurement program, and the lifting device 360 lifts the lower surface member 340 so that the measuring object 310 surface contacts the lower surface member 340 and the delay member 310 at a predetermined surface pressure (step 4-1).

Then, the measurement controller 400 controls the voltage application device 350 as commanded by the measurement program, and a predetermined voltage is applied to the electrodes 311 and 341 by the voltage application device 350 (step 4-2).

Subsequently, the measurement controller 400 controls the transducer 320 which includes the transmission/reception circuit 330, the voltage application device 350, and the lifting device 360 as commanded by the measurement program, by this, the measurement of the first reflection wave and the second reflection wave is conducted (step 4-3). And, the measurement controller 400 derives the viscoelasticity property by using at least two among the property of the incident wave, the property of the first reflection wave measured at the standard condition, the property of the first reflection wave measured at the measurement condition, and the property of the second reflection wave (step 4-4). The first reflection wave is a reflection wave which reflects the incident wave entered to the delay member at a position where the first surface 301a of the measuring object 301 is disposed, and the second reflection wave is a reflection wave which reflects the incident wave entered to the delay member 301 at a position where the second surface 301b is disposed.

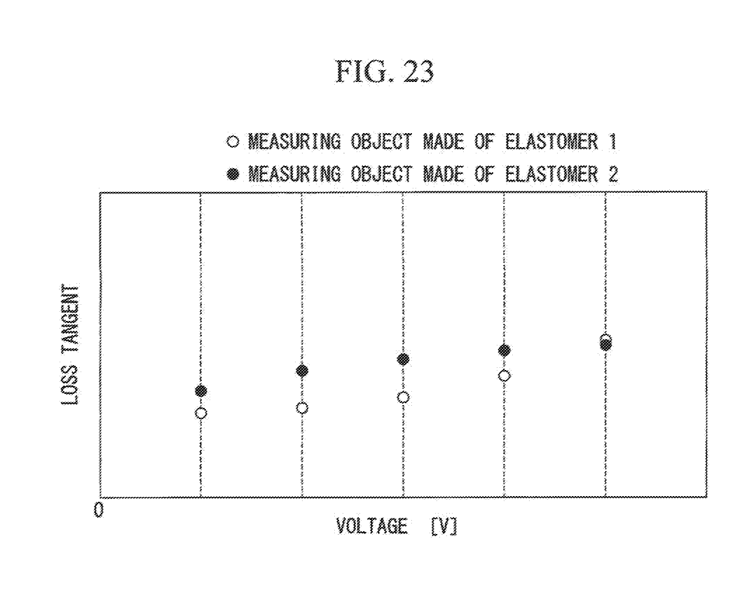

Moreover, while changing applied voltage, conduct the measurement steps 4-3 to 4-4 (step 4-5), and repeatedly conduct step 4-5 for plural times (step 4-6). Next, store the derived viscoelasticity property in a memory such as a hard disk of the measurement controller, and output it to the display device 410 (step 4-7). The display device 410 shows the data accepted from the measurement controller 400. For example, as shown in FIG. 23, a graph whose vertical axis indicates the applied voltage and whose horizontal axis indicates the loss tangent is displayed.

In the steps 4-3 and 4-4, for example, the measurement of the reflection wave is conducted in accordance with description after the paragraph 0080 of Japanese Unexamined Patent Application Publication No. 2008-107306, and the viscoelasticity property is derived by using a data of the reflection wave of the referenced reflection wave obtained at the standard condition where the contacting surface 310a of the delay member 310 does not come into contact with the measuring object 301, and a data of the reflection wave of the first reflection wave obtained at the measurement condition where the contact surface 310a of the delay member 310 comes into contact with the measuring object 301.

Like this, in this embodiment, since the electric field is applied to the measurement object 301 by using the electrodes 311, 341 and the voltage application device 350 of which the measurement device comprises, the viscoelasticity can be measured by making the condition of the magnetic field applied by the device as a standard. That is, even when the viscoelasticity of plural kinds of the measuring object 301 is measured, it is possible to quantitatively evaluate changes in the viscoelasticity which is caused by the electric field of plural kinds of the measurement object by fixing a condition of the electric field which is applied by the device so that it can be made as a standard.

Also, since the first and the second electrodes 311, 341 are included with the measurement device, the first and the second electrodes 311, 341 surface contact with the first and the second surfaces 301a, 301b respectively, the condition of the electric field in connection with the measuring object 301, such as a distance between the measuring object 301 and electrodes 311, 341, or the like, can be stable. In addition, in order to measure the viscoelasticity, it is necessary to make sure that the delay member 310 surface contacts with the measuring object 301, however, it becomes possible that the delay member 310 stably surface contacts with the first surface 301a of the measuring object 301 and that the electrodes 311, 341 surface contact with the measuring object 301 by surface contacting of the second electrode 341 with the second surface 301b of the measuring object 301.

Further, the embodiment of this invention is configured so that the viscoelasticity is derived for plural times by changing the condition of the electric field which is applied to the measuring object 301 by controlling the voltage application device 350, thus, a trend of the viscoelasticity with regard to the condition of the electric field can be obtained. Due to this, effective development of an elastomer whose property is changed by the electric field or a functional component using such elastomer becomes possible, and, it is also possible to know an unknown property and a trend of a newly developed material easily and certainly.

Here, it is possible to derive an elastic modulus or a solidity of the measuring object 301 after conducting the step 4-1, and before conducting the step 4-2. For example, first of all, the measurement controller 400 controls the voltage application device 350 as commanded by the measurement program so that a predetermined voltage is applied to a portion which is disposed between the electrodes 311, 341 by the voltage application device 350 (preparation step 1). Subsequently, the measurement controller 400 controls the lifting device 360 as commanded by the measurement program, and a force which holds the measuring object 301 between the lower surface member 340 and the delay member 310 is gradually changed by the lifting device 360, at such time, a static elastic modulus of the measuring object 301 is calculated on the basis of a load which is obtained from the load cell of the lifting device 360 and a cross-sectional area of the measuring object 301 in the horizontal direction (preparation step 2). Next, change the voltage which is applied in the preparation step 1, and conduct the preparation step 2 (preparation step 3), and further, repeatedly conduct the preparation step 3 for plural times (preparation step 4). By this, the elastic modulus of the measuring object 301 depending on each voltage is derived.

Subsequently, make the voltage and the elastic modulus of the measuring object 301 correspond with each other and store it to the memory such as a hard disk of the measurement controller 400 or the like (preparation step 5). It is possible to measure the solidity and the elastic modulus of the measuring object 301 in response to each voltage by using a manual solidity meter or different kinds of means, and to store such value by making correspondent with the voltage in the measurement controller 400.

Alternatively, it is also possible to measure a degree of the friction coefficient or the slip ratio with regard to the viscoelasticity in advance, and to store the friction coefficient or the slip ratio in the measurement controller 400 so as to correspond with each of values of the viscoelasticity respectively.

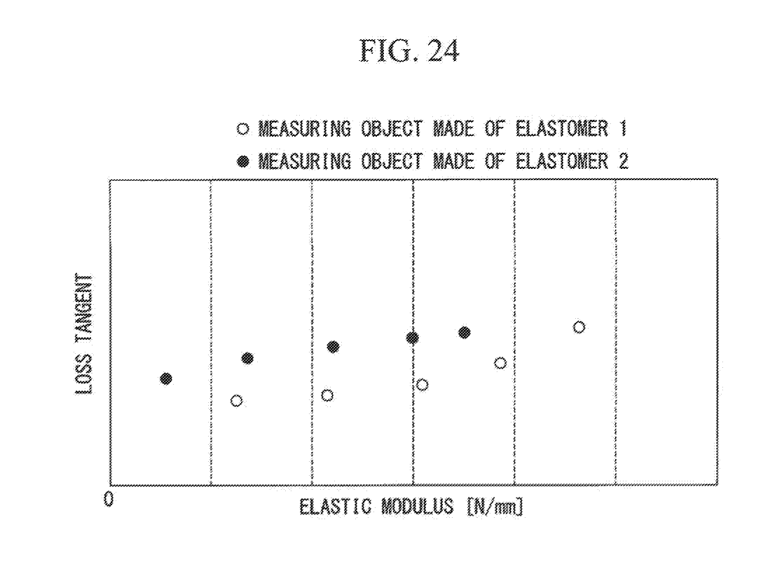

In this case, it is possible to correspond the viscoelasticity which is derived in the steps 4-1 to 4-6 with the elastic modulus, the solidity, the friction coefficient, or the slip ratio of the measuring object in response to a voltage when deriving, and to output or store the such in the memory. For example, as shown in FIG. 24, a graph whose horizontal axis indicates the static elastic modulus and whose vertical axis indicates the loss tangent, and a graph whose horizontal axis indicated the loss tangent and whose vertical axis indicates the friction property such as the friction coefficient, the slip ratio, and the like, can be output to the display device 410. By doing so, it becomes possible to understand the friction property, such as the friction coefficient and the slip ratio and the like, which is one of the major parameter for designing the functional parts, and the viscoelasticity of the elastomer whose physical property is changed by the electric field by corresponding with the solidity or the elastic modulus, and it is also possible to accomplish efficient development of the functional parts. Also, unknown property and trend of a new development material can easily and precisely be known.

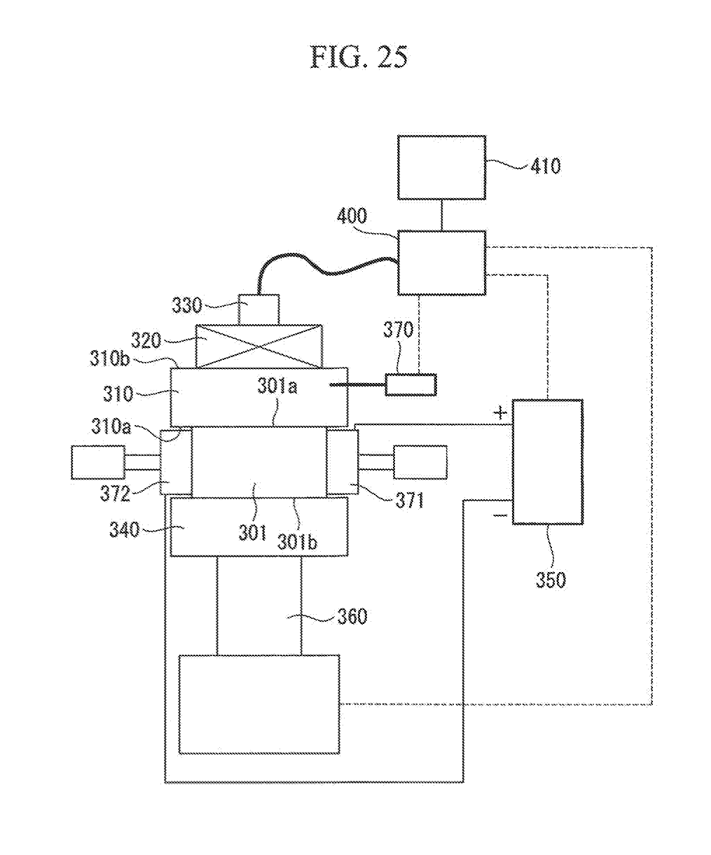

The viscoelasticity property measurement device according to the seventh embodiment of the present invention is described below with reference to FIG. 25.

As shown in FIG. 25, the device of this embodiment has a first and a second electrodes which are disposed at a different position compared with the device according to the sixth embodiment, however, the other configurations thereof are the same. Only differences between the present embodiment and the sixth embodiment are described below.

In this embodiment, the first electrode 311 which is provided on the lower surface of the delay member, and the second electrode 341 which is provided on the upper surface of the lower surface member 340 are omitted, instead, a first electrode member 371 and a second electrode member 372 are provided so as to surface contact with a pair of side faces which are arranged so as to face the measuring object 301 respectively. Electrode members 371, 372 are made of a metallic material, and are connected to the voltage application device 350 respectively. Electrode members 371, 372 are supported by a rod of the electric cylinder respectively, and electric cylinders force the electrode members 371, 372 to surface contact with the side faces of the delay member 310 respectively. It may be possible to arrange the electrode members 371, 372 so as to make a slight gap between the electrode members 371, 372 and the side faces, however a condition of the electric field with regard to the measuring object 301 becomes stable when the electrode members 371, 372 and the side faces surface contact with each other.

In this embodiment, as conducted in the steps 4-1 to 4-7 of the sixth embodiment, deriving, storing, and outputting of the viscoelasticity property are conducted as well. In addition, in the step 4-2, in order to apply voltage, the electrode members 371, 372 are used instead of the electrodes 311, 341.

In this embodiment also, since the electrode members 371, 372 and the voltage application device 350 are used to apply the electric filed to the measuring object 301, a condition of the electric field which is applied by the device can be a criteria to conduct the evaluation.

Moreover, since the first and the second electrode members 371, 372 surface contact respectively with the side faces which are arranged so as to face the measuring object 301 with each other, the condition of the electric field with regard to the measuring object 301 can be made stable. Also, it is possible to evaluate a change of the viscoelasticity property when applying the electric field to the measuring object 301 from a surface which is different from the incident surface of the sonic wave. Furthermore, it is possible to evaluate a change of the viscoelasticity property when applying the electric field in a right angle direction toward the incident direction of the sonic wave.

In this embodiment, the above-described effect of the sixth embodiment in connection with an unchanged configuration can also be gained.

Also, by providing the first and the second electrode members 371, 372 to the sixth embodiment, a measurement which uses the first and the second electrode members 371, 372, and a measurement which uses the first and the second electrodes 311, 341 can be conducted selectively or simultaneously.

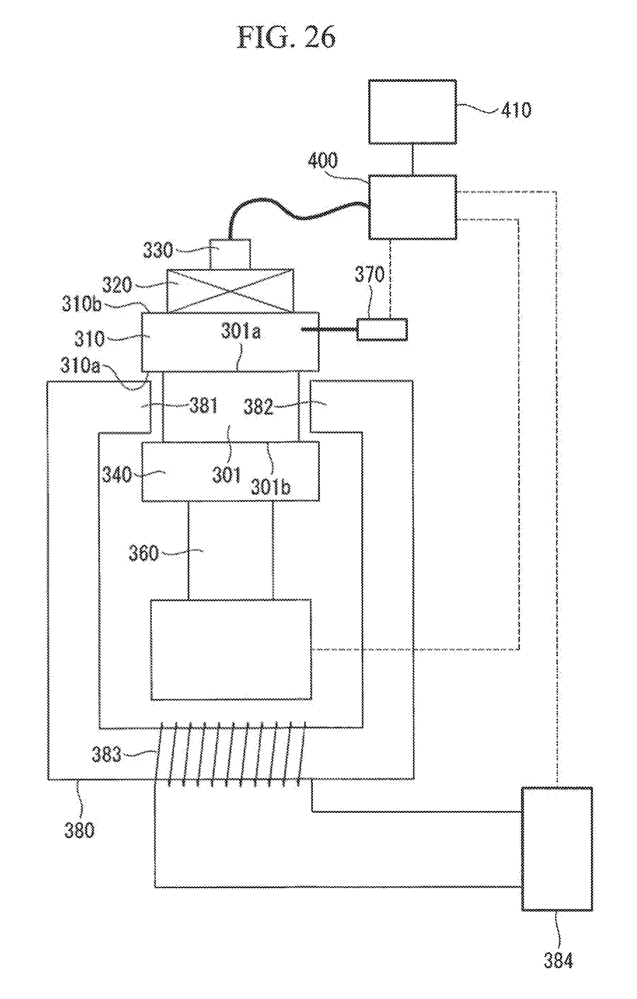

The viscoelasticity property measurement device in accordance with the eighth embodiment is described with reference to FIG. 26.

As shown in FIG. 26, the device of this embodiment is different from that of the sixth embodiment in a point of proving a positive electrode and a negative electrode instead of the first and the second electrodes, however, the other configurations thereof are the same. Only the differences between this embodiment and the sixth embodiment are described below.

In this embodiment, the first electrode 311 which is provided on the lower surface of the delay member, and the second electrode 341 which is provided on the upper surface of the lower surface member 340 are omitted, instead, a positive electrode 381 and a negative electrode 382 are provided so as to approximate to a pair of side faces which are arranged so as to face the measuring object 301 respectively. A positive electrode 481 and a negative electrode 482 are both ends of U-shaped a metal rod, a coil 483 is wound around a central part of the metal rod 480 in the lengthwise direction, current is provided to the coil 483 by a power supply 384. The power supply 484 is connected to the measurement controller 400, the measurement controller 400 controls the power supply 384 as commanded by the measurement program, and can change a condition of the magnetic field which is formed between the positive electrode 381 and the negative electrode 382.

In this embodiment, as conducted in the steps 4-1 to 4-7 of the sixth embodiment, deriving, storing, and outputting of the viscoelasticity property are conducted as well. In addition, in the step 4-2, in order to apply the magnetic field, the positive electrode 381 and the negative electrode 382 are used instead of the electrodes 311, 341.

In this embodiment also, since the positive electrode 381, the positive electrode 382, and the power supply 384, which are provided with the measurement device, apply the magnetic field to the measuring object 301, a condition of the magnetic field which is applied by the device can be a criteria to conduct the evaluation. Also, since the measuring object 301 is placed between the positive electrode 381 and the negative electrode 382, the condition of the magnetic field which is applied to the measuring object 301 can be made stable.

In this embodiment, the above-described effect of the sixth embodiment in connection with an unchanged configuration can also be gained.

Furthermore, in the sixth and seventh embodiments, the electrodes 341, 371, 372 are formed by using a metal surface. Whereas, the electrodes 341, 371, 372 can be formed by providing a plurality of conductive wires parallel to a flat surface, also, the electrodes 341, 371, 372 can be made by forming a more planar net on the conductive wires.

Also, the electrode 311 can be formed from a thin metallic film, and the delay member 310 can be formed from a material with sound impedance which is close to or same with the one used in the metal of the electrode 311.

It is possible to provide a pair of the electrodes which apply the electric field, or the positive electrode and the negative electrode which apply the magnetic field in other manners, for example, it is also possible to provide a punctate electrode instead of a sheet-shaped electrode.

In addition, in the sixth to the ninth embodiment, by obtaining the property of the reference reflection wave per temperature of the delay member 310, the corrected reference data is determined on the based of the obtained property, and the viscoelasticity property is derived on the basis of the property of the first reflection wave and the property of the corrected reference data at the measurement condition so as to compensate temperature. Whereas, the viscoelasticity property can be derived on the basis of the property of the first refection wave at the measurement condition and the property of the reference reelection wave which is measured in advance without temperature compensation.

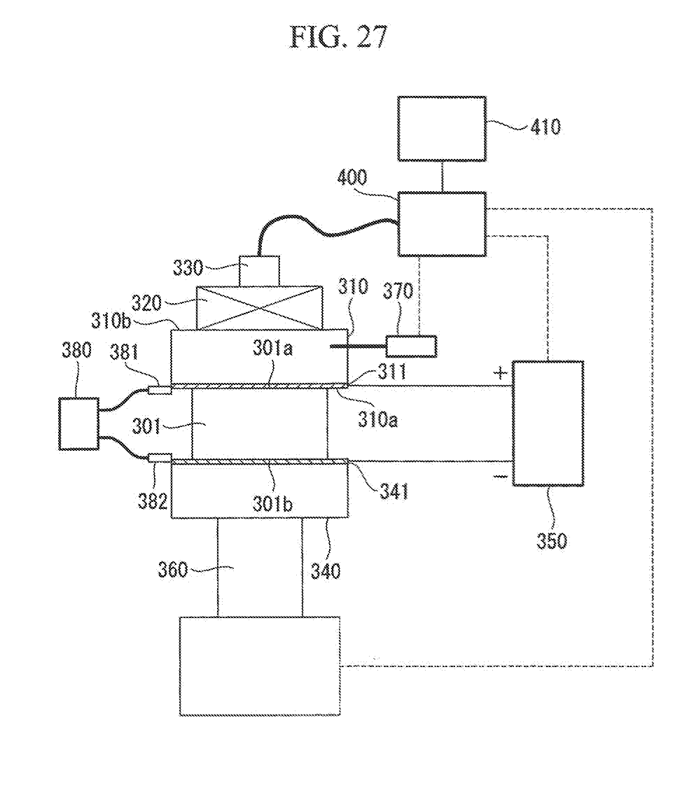

Moreover, in the sixth to ninth embodiments, it is also possible to measure the electrical property of the measuring object 301. For example, as shown in FIG. 27, it is possible to connect the electrodes 311, 341 with a pair of measuring terminals 381, 382 of an impedance measurement device 380 respectively so as to measure an impedance of the measuring object 301 by using the impedance measurement device 380 in the sixth embodiment. In this case, the pair of the measurement terminals 381, 382 are to be electrically connected to surfaces which are located so as to face the measuring object 301 with each other. Also, the measurement device 380 is connected to the measurement controller 400, the measurement device 380 measures an impedance of an object with which the measuring terminals 381, 382 come in contact by the known method, such as bridge method, resonance method, I-V method, RF I-V method, Auto-Balancing-Bridge method, and the like.

When measuring the impedance, for example, the measurement controller 400 controls the measurement device 380 as commanded by the measurement program, and starts measuring the impedance of the measuring object 301 using the measurement device 380 a little while before measuring the reflection wave in the step 4-3 (electrical property measurement step 1).

Subsequently, when the measurement controller 400 receives a measurement result from the measurement device 380 as commanded by the measurement program, obtains impedances for both cases respectively, one of which is when the incident wave from the transducer 320 passes through the measuring object 301, and another one of which is when the incident wave from the transducer 320 does not pass through the measuring object 301, so that the both cases are to be compared to evaluate a change of the impedance which is let by the incident wave (electrical property measurement step 2). Next, repeat the electrical property measurement steps 1 and 2 every time the steps 4-5 and 4-6 are conducted (electrical property measurement step 3).

Yet, in the above description, the impedance was measured and evaluated, however, it is alternatively be possible to use a device which measures an electric property (voltage and current) in a measuring status of the reflection wave as the measurement device 380, so as to evaluate different kinds of electrical properties of the impedance. Moreover, it is also possible to make the measurement terminals 381, 382 come in contact with a par of side faces which are arranged so as to face the measuring object 301 with each other.

With this configuration, since this device is not only possible to evaluate a material which is capable of enlarging possibility of function and performance of friction or the like, but also possible to extract a change in physical property at high frequency oscillation as a change in the electrical property, it is useful for a basic research on a material in the field of sensing. Also, since the evaluation of the viscoelasticity and the evaluation of the electric property can be associated with each other, knowledge from the obtained electrical property allows optimization of improvement of materials.

It is possible to measure the viscoelasticity property when a force in pulse waveform is applied to the measuring object 301 while giving a little modification to the configuration of the viscoelasticity measurement device, and changing a certain frequency such as between 1 Hz to several hundred Hz, or a frequency between 1 Hz to a several hundred Hz so as to apply a pressure at 2 Mps, or the like to the measuring object 301, for example. Also, it is certainly possible to apply a force in sine waveform instead of that of pulse waveform as well.

In such case, it is possible to provide a vibration head instead of the delay member 310, and an automatic or hydraulic actuator which vibrates the vibration head instead of the transducer 320. Also, with the vibration head, for example, a first electrode 341 is provided with a contacting surface which comes in contact with the first surface of the measuring object 301.

Moreover, the measurement controller 400 is connected to the actuator so as to control the actuator, and to store the measurement program which derives the viscoelasticity property on the basis of a vibration wave of the actuator and a measurement wave which is received from the load cell of the lifting device 360.

With this device, a method for measuring the viscoelasticity of a measuring object 1 is described below.

Firstly, place the measuring object 301 which is formed in a predetermined size on the lower surface member 340, and input a measurement start instruction to the measurement controller 400 at the same time, then the measurement controller 400 accepts the instruction, and the measurement controller 400 controls the lifting device 360, then the lifting device 360 lifts the lower surface member 340 as commanded by the measurement program so that the measuring object 301 surface contacts with the lower surface member 340 and the vibration head at a predetermined surface pressure (step 5-1).

Next, the measurement controller 400 controls the voltage application device 350 as commanded by the measurement program, and applies a predetermined voltage to the electrodes 311, 341 by using the voltage application device 350 (step 5-2).

And then, the measurement controller 400 controls the actuator so as to vibrate as commanded by the measurement program, by this, the measurement controller 400 obtains the measurement wave from the load cell of the lifting device 360 (step 5-3). And, the measurement controller 400 derives the viscoelasticity property by using the vibration wave of the actuator and the measured wave (step 5-4).

Subsequently, conduct the steps 5-3 to 5-4 while changing the voltage which is applied in the step 5-2 (step 5-5), and repeat the step 5-5 for a plural times (step 5-6). Next, store the derived viscoelasticity property in the memory such as the hard disk of the measurement controller or the like, and output the same to the display device 410 at the same time (step 5-7). The display device 410 displays a data accepted from the measurement controller 400.

Yet, since the above-described viscoelasticity measurement is conducted at a desired temperature, it is also possible to provide a temperature adjusting chamber having at least the measuring object 310, the delay member 310, the lower member, and the vibration head inside thereof, and to configure so that temperature in the temperature adjusting chamber is controlled by the measurement controller 400.

For example, tan δ of about 10 Hz or solidity is important for the rolling resistance, and a correlation between such property and the rolling resistance when applying the pulse waveform force is said to be good. Although an adhesive friction cannot be measured directly, since it depends on a genuine contacting area, an effect from a storage elastic modulus and solidity at a relatively low speed is considered to be large. Therefore, it becomes possible to improve material development effectively by effectively considering the optimization of the property by changing the electric field or the magnetic field by using the viscoelasticity property measurement device.

Yet, in the above-described embodiments, the electric field which is applied to the elastomer may be a direct electric field, an AC electric field, or a combination of the both.

The inventor has arrived at the following aspect of the present invention.

A tire according to a first aspect of the present invention comprises a tread member which has a contact surface made of an elastomer whose viscoelasticity is changed by applying an electric field or a magnetic field.

According to the first aspect, hysteresis loss near the contact surface of the tread member can be adjusted by changing the viscoelasticity property of the elastomer, which forms the contact surface of the tread member, by applying the magnetic field toward the contact surface of the tread member.

According to a second aspect of the present invention, the tire further comprises a plurality of electrodes arranged with an interval between each pair of the electrodes, and in the tread member or a tire constructing member disposed at a radial inside of the tread member, for applying the electric field toward the contact surface of the tread member, or a plurality of magnetic poles arranged with an interval between each pair of the magnetic poles, in the tread member or the tire constructing member, for applying the magnetic field toward the contact surface of the tread member.

With the second aspect, in the tread member on which the contact surface is formed, or in the tire constituting member located at a radial inside of the tread member, the plurality of electrodes are located. Therefore, it is not necessary to provide the electrodes in a member which does not from the tire. Moreover, since the tire constituting member provided at a radial inside of the tread member is located at a vicinity of the tread member, the electric field or the magnetic field can be efficiently applied to the contact surface side of the tread member.

According to a third aspect of the present invention, in the aforementioned tires, each of the electrodes is a wire member which is provided in the tread member or an elastomer member disposed at a radial inside of the tread member and which extends in a circumferential direction of the tire so as to form a spiral shape.

According to the third aspect, by disposing wires in the tread member or in the elastomer member disposed at the radial inside of the tread member so that the wires extend along a spiral-like shape which extends along the tire circumferential direction at the time when the tire is not vulcanized, the electrodes can be placed so as to extend spirally in the vulcanized tire. Alternatively, by winding the ribbon-shaped elastomer, which has the wires, along the circumferential direction, the tread member for forming the unvulcanized tire or the elastomer member which is placed at the radial inside of the tread member in the unvulcanized tire is formed, and thereby it is possible to provide the electrodes so as to extend spirally in the vulcanized tire. With this configuration, the electrodes are efficiently placed in the tire. Also, since the electrodes are placed inside the tire, the frictional wear or breakage of the electrodes does not occur easily.

According to a fourth aspect of the present invention, in the aforementioned tires, each of the electrodes is a wire member which is provided in the tread member or an elastomer member disposed at a radial inside of the tread member and which extends from one of side portions of the tire to the other side portion through a tread portion of the tire.

According to the fourth aspect, in a state in which the tire is not vulcanized, a plurality of electrodes can be arranged so as to extend toward one of the side portions via the tread portion from the other side portion by arranging the plurality of wires which extend toward one of the side portions via the tread portion from the other side portion in the tread member or in an elastomer member which is disposed at a radial inside of the tread member. Alternatively, for example, when the tire has a carcass member in which a plurality of reinforcing members which extend toward one of the side portions via the tread portion from the other side portion of the tire is provided, by using at least part of the reinforcing members as the wires for the electrodes, the plurality of electrodes can be arranged so as to extend toward one of the side portions via the tread portion from the other side portion in the vulcanized tire. Therefore, the electrodes can be arranged efficiently in the tire. Also, since the electrodes are placed inside the tire, the frictional wear or breakage of the electrodes does not occur easily.

According to a fifth aspect of the present invention, in the aforementioned tires, at least part of the electrodes is provided in grooves of a tread pattern provided on a tread portion of the tire.

According to the fifth aspect, because the electrodes can be formed inside the grooves of the tread pattern by vapor deposition or the like, it becomes possible to form the electrodes in the tire which has been vulcanized, and therefore the electrodes can be arranged efficiently in the tire. Also, since the grooves of the tread pattern does not come in contact with road surfaces, the frictional wear or breakage of the electrodes does not occur easily. Further, it is easy to find breakage of the electrodes and to conduct maintenance.

According to a sixth aspect of the present invention, in the aforementioned tires, at least part of the rest of the electrodes which are not provided in the grooves is provided in a block portion of the tread pattern.

According to the sixth aspect, since at least part of the electrodes is disposed in the blocks which generates hysteresis loss, it becomes possible to adjust the hysteresis loss more efficiently.

According to a seventh aspect of the present invention, the aforementioned tires further comprise a low permittivity member which is disposed between the electrodes and whose permittivity is equal to or less than ½ of that of the elastomer forming the tread portion.

According to the seventh aspect, the electrical field can be applied more effectively to the elastomer of the tread member because the low permittivity member whose permittivity is lower than that of the elastomer of the tread member is disposed between the pair of electrodes, which causes a situation in which the electric field goes through the elastomer of the tread member which has a higher permittivity, instead of going through the low permittivity member that is located at the shortest way between the electrodes.

According to an eighth aspect of the present invention, in the aforementioned tires, the wire member has a side surface that extends along an axis of the wire member and that is provided with a planar surface portion which faces the contact surface of the tread member.

According to the eighth aspect, the planar surface portion is capable of applying the electric field toward the contact surface of the tread member more efficiently because the electric flux density generated from the planar surface portion as a side surface of the wire tends to be higher than the electric flux density generated from the different side surface of the wire, and because the planar surface portion faces the contact surface of the tread member.

According to a ninth aspect of the present invention, in the aforementioned tires, the elastomer member is a carcass member, a belt member disposed at a radial outside of the carcass member, or a ribbon-shaped member which is disposed at a radial outside of the carcass member and which is wound in a spiral shape extending in a circumferential direction of the tire, and the electrodes are composed of part of wire members which are provided in the carcass member so as to be parallel to each other, or part of wire members provided in the belt member so as to be parallel to each other, or each of the electrodes is composed of a wire member provided in the ribbon-shaped member.

According to the ninth aspect, since the wire members which form the electrodes are part of the wire members which are provided in the carcass member so as to be parallel to each other, or the wire members provided in the belt member so as to be parallel to each other, or each of the electrodes is composed of the wire member provided in the ribbon-shaped member, it becomes unnecessary to increase the number of the tire constituting members in order to provide the electrodes, and it becomes possible to reduce time and effort for considering a solidity balance of the tire or a balance between the constituting members. Also, it is possible to prevent or reduce increment of the manufacturing cost and the tire weight, which is caused by employing new constituting members.

According to a tenth aspect of the present invention, the aforementioned tires further comprise a power generation element, a power storage element, or a power reception portion of a non-contact power supply system, each of which is attached to a tread portion or a side portion of the tire to supply electrical potential or current to the electrodes or the magnetic poles.

According to the tenth aspect, the electrical potentials to the electrodes are supplied from the power generation element and/or the power storage element which are mounted on the side portion or tread portion of the tire, it becomes possible to eliminate or simplify a configuration for supplying the electrical potentials to the electrodes from the outside of the tire for supplying the electrical potentials to the electrodes.

A vehicle according to an eleventh aspect of the present invention comprises any one of the aforementioned tires, and a controller for controlling electrical potential or an amount of current supplied to the electrodes or the magnetic poles in response to an operation state or behavior of the vehicle.

According to the eleventh aspect, coexistence of improvements in both of the grip force and the low fuel consumption can be accomplished in a high level by changing the viscoelasticity property of the elastomer which forms the contact surface of the tread member on the basis of the operation state or the behavior of the vehicle in order to adjust the hysteresis loss near the contact surface of the tread member, which largely affects the grip force and the rolling resistance of the tire.

A traffic control system according to a twelfth aspect of the present invention comprises the following elements: a detection device for detecting condition of a road surface, weather condition, a state of traffic, an operation state of a vehicle, or behavior of the vehicle; a traffic controller which transmits a control signal regarding electrical potential or an amount of current to be supplied to the electrodes or the magnetic poles to a controller of the vehicle described above and which exists in a certain area.

According to the twelfth aspect, since the property of the tread portion of the tire of each of the vehicles existing in a certain area can be changed on the basis of a detection result of the detection device, the property of the tread portion of the tire of each of the vehicles existing in the certain area may forcibly be changed on the basis of weather condition, for example.

A friction property measurement apparatus according to a thirteenth aspect of the present invention comprises: a roller which has an outer circumference surface made of an elastomer whose property is changed by an electric field of a magnetic field applied thereto; an applying unit which applies the electric field or the magnetic field to the elastomer; a pushing force adjusting unit which adjusts a pushing force for pushing the outer circumference surface against a sample member; a roller driving unit which drives the roller to move the sample member toward a predetermined direction; a moving amount measurement device which measures the amount of movement of the sample member in the predetermined direction; and a measurement controller which controls the roller driving unit so as to move the sample member toward the predetermined direction, and which receives the amount of movement at the time of said movement, and also which calculates a friction property between the roller and the sample member using at least the received amount of movement and the amount of movement of the outer circumference surface of the roller so that the friction property becomes related to the pushing force by the pushing force adjusting unit at the time of said movement.

With the thirteenth aspect, by calculating the friction property with a variety of properties of the elastomer which forms the outer circumference surface of the roller, changing electric fields or magnetic fields applied to the elastomer, it becomes possible to efficiently conduct measurement of the friction property for analyzing, realizing, and adjusting control parameters of the elastic field or the magnetic field for the elastomer.

Also, the friction property is calculated using at least the amount of movement of the sample member and the amount of movement of the outer circumference surface of the roller so that the friction property becomes related to the pushing force by the pushing force adjusting unit at the time of said movement. Therefore, it becomes possible to derive a friction property which is similar to a friction property of an actual function part such as a tire or the like which generates friction force and also generating a slight slip between the part and the contact surface, or a friction property of an actual function part such as a paper feed roller or the like which generates friction force and also generates a slight slip between the part and the fed member, for example. Therefore, it is possible to analyze, realize, and adjust control parameters of the electric field or the magnetic field for the elastomer in conditions which is the same or similar to those in actual parts or machines. The force measuring unit may be a device utilizing piezoelectric effect of the tire.

A friction property measurement apparatus according to a fourteenth aspect of the present invention comprises: a roller which has an outer circumference surface made of an elastomer whose property is changed by an electric field of a magnetic field applied thereto; an applying unit which applies the electric field or the magnetic field to the elastomer; a pushing force adjusting unit which adjusts a pushing force for pushing the outer circumference surface against a sample member; a driving which moves, in a predetermined direction, the sample member relative to the outer circumference surface of the roller by driving the roller or directly applying the sample member; a force measuring unit which measures force toward the predetermined direction applied to the sample member when the sample member is relatively moved by the driving unit in the predetermined direction; and a measurement controller which controls the driving unit so as to relatively move the sample member in the predetermined direction, and which calculates a friction property between the roller and the sample member by using at least the pushing force by the pushing force adjusting unit at the time of said movement and force measured by the force measuring unit at the time of said movement.

With the fourteenth aspect, by calculating the friction property with a variety of properties of the elastomer which forms the outer circumference surface of the roller, changing electric fields or magnetic fields applied to the elastomer, it becomes possible to efficiently conduct measurement of the friction property for analyzing, realizing, and adjusting control parameters of the elastic field or the magnetic field for the elastomer.

Also, since the friction property is calculated by using at least the pushing force measured by the force measuring unit, it becomes possible to derive a friction property which is similar to a friction property of an actual function part such as a tire or the like which generates friction force and also generating a slip between the part and the contact surface. Therefore, it is possible to analyze, realize, and adjust control parameters of the electric field or the magnetic field for the elastomer in conditions which is the same or similar to those in actual parts or machines.

A friction property measurement apparatus according to fifteenth aspect of the present invention comprises: a roller which has an outer circumference surface made of an elastomer whose property is changed by an electric field of a magnetic field applied thereto; an applying unit which applies the electric field or the magnetic field to the elastomer; a pushing force adjusting unit which adjusts a pushing force for pushing the outer circumference surface against a sample member; a roller driving unit which drives the roller to move the sample member toward a predetermined direction; and a measurement controller which controls the driving unit so as to move the sample member in the predetermined direction, and which calculates a friction property between the roller and the sample member by using at least the pushing force by the pushing force adjusting unit at the time of said movement and torque for driving the roller at the time of moving the sample member in the predetermined direction by the driving unit.

With the fifteenth aspect, by calculating the friction property with a variety of properties of the elastomer which forms the outer circumference surface of the roller, changing electric fields or magnetic fields applied to the elastomer, it becomes possible to efficiently conduct measurement of the friction property for analyzing, realizing, and adjusting control parameters of the elastic field or the magnetic field for the elastomer.

Also, since the friction property is calculated by using at least the pushing force and the torque for driving the roller, it is possible to obtain a friction resistance, which has affects on rolling resistance, generated between the outer circumference surface of the tire and the contact surface during one rotation of the tire. Therefore, it is possible to analyze, realize, and adjust control parameters of the electric field or the magnetic field for the elastomer in conditions which is the same or similar to those in actual parts or machines.

According to a sixteenth aspect of the present invention, the friction property measurement apparatus further comprises a memory unit which stores conditions of the electric field or the magnetic field to be applied by the applying unit so as to be related to viscoelasticity properties of the elastomer which forms the outer circumference surface of the roller, and the measurement controller conducts output and/or a storing process with the memory unit so that the calculated friction property is related to at least one of the viscoelasticity properties corresponding to the condition of external field at the time of the calculation.

With the sixteenth aspect, since friction properties are stored in the memory unit or output so as to be related to the viscoelasticity properties of the elastomer, relationships between the viscoelasticity properties of the elastomer and the friction properties are accumulated, and the relationships between the viscoelasticity properties of the elastomer and the friction properties are obtained without much time consumption and effort.

A viscoelasticity property measurement apparatus according to a seventeenth aspect of the present invention comprises: a delay member whose surface contacts a first surface of a measuring object which has the first surface and a second surface which is opposed to the first surface; a radiating unit which radiates sonic wave to a radiating surface of the delay member which is opposite to a contact surface of the delay member which comes into contact with the first surface; a receiving unit which receives a reference reflection wave at the contact surface which is the reflection wave of the radiated wave radiated into the delay member when the delay member does not come into contact with the measuring object, a first reflection wave at the first surface which is the reflection wave of the radiated wave radiated into the delay member when the delay member has contact with the first surface of the measuring object, and a second reflection wave at the second surface which is the reflection wave of the radiated wave radiated into the delay member; a measurement controller which calculates viscoelasticity property of the measuring object by using at least two of a property of the radiated wave, a property of the reference reflection wave, a property of the first reflection wave, and a property of the second reflection wave; and an applying unit which applies a electric field or a magnetic field to the measuring object.

With the seventeenth aspect, since the electric field or the magnetic field is applied by the applying unit provided in the measurement apparatus, it is possible to conduct measurement of the viscoelasticity property on the basis of the conditions of the electric field or the magnetic field applied by the apparatus, and therefore it is possible to quantitatively evaluate changes of the viscoelasticity properties of the various measuring objects caused by the electric field or the magnetic field.

According to a eighteenth aspect of the present invention, the viscoelasticity property measurement apparatus further comprises a memory unit which stores conditions of the electric field or the magnetic field to be applied by the applying unit so as to be related to solidity or elastic modulus, and the measurement controller conducts output and/or a storing process with the memory unit so that the calculated viscoelasticity property is related to at least one of the solidity or elastic modulus corresponding to the condition of the electric field of the magnetic field at the time of the calculation.

In this configuration, the solidity and the elastic modulus of an elastomer become general design indexes and mainly required specifications of the function parts using elastomer.

In the eighteenth aspect, each of the calculated viscoelasticity properties is related to the solidity or the elastic modulus of the elastomer which corresponds to the condition of the electric field or the magnetic field, and it is output or stored in the memory unit. Therefore, it becomes possible to know the viscoelasticity property of the elastomer so that that is related to the solidity or the elastic modulus each of which is one of the main indexes for designing a function part, and it is possible to efficiently conduct development of the function part. Also, it is possible to find unknown properties or tendencies of newly developed materials in an easy and precise way.

### ADVANTAGEOUS EFFECTS OF INVENTION

The tires of the aforementioned aspects afford an advantage of enabling control of hysteresis loss near the contact surface of the tread member of the tire.

### REFERENCE SIGNS LIST

1 tread portion
2 bead portion
3 side portion
10 tread member
12a electrode
12b electrode
12c low permittivity member
20 belt member
30 bead member
40 side member

1. A tire comprising:
a tread member which has a contact surface made of an elastomer whose viscoelasticity is changed by applying an electric field; and
a pair of electrodes which are located in the tread member or a tire constructing member located at a radial inside of the tread member so that the pair of electrodes are arranged with an interval therebetween, and which apply the electric field to a contact surface side of the tread member,
wherein the electric field is applied to the contact surface side by applying a potential difference between the pair of electrodes by an electric power source,
wherein each of the electrodes is located in the tread member or an elastomer member located at the radial inside of the tread member, and each of the electrodes is a wire extending along a circumferential direction of the tire to be a spiral shape,
wherein an outer surface of the tread member is provided with a plurality of blocks each of which circumferentially continues in the circumferential direction of the tire,
wherein the pair of electrodes are located in each of the circumferentially continuing blocks.

2. A tire comprising:
a tread member which has a contact surface made of an elastomer whose viscoelasticity is changed by applying a magnetic field; and
a pair of magnetic poles which are located in the tread member or a tire constructing member located at a radial inside of the tread member so that the pair of magnetic poles are arranged with an interval therebetween, and which apply the electric field to a contact surface side of the tread member,
wherein at least one of the magnetic poles is made of an electromagnet,
wherein each of the magnetic poles is located in the tread member or an elastomer member located at the radial inside of the tread member, and which extend in a circumferential direction of the tire so that the magnetic poles extend along each other,
wherein an outer surface of the tread member is provided with a plurality of blocks each of which circumferentially continues in the circumferential direction of the tire,
wherein the pair of magnetic poles are located in each of the circumferentially continuing blocks.

3. A tire comprising:
a tread member which has a contact surface made of an elastomer whose viscoelasticity is changed by applying an electric field; and
a pair of electrodes which are located in the tread member or a tire constructing member located at a radial inside of the tread member so that the pair of electrodes are arranged with an interval therebetween, and which apply the electric field to a contact surface side of the tread member,
wherein at least one of the electrodes is provided in grooves of a tread pattern provided on a tread portion of the tire.

4. The tire according to claim 3, at least part of the other one of the electrodes, which are not provided in the grooves, is provided in a block portion of the tread pattern.

5. A tire comprising:
a tread member which has a contact surface made of an elastomer whose viscoelasticity is changed by applying an electric field; and
a plurality of electrodes which are located in the tread member or a tire constructing member located at a radial inside of the tread member so that each pair of the electrodes are arranged with an interval therebetween, and which apply the electric field to a contact surface side of the tread member,
wherein the tire further comprises a low permittivity member which is disposed between the electrodes and whose permittivity is equal to or less than ½ of that of the elastomer forming the tread portion.

6. The tire according to claim 1, wherein each of the electrodes is a wire, and wherein a side surface that extends along an axis of the wire member is provided with a planner surface which faces the contact surface of the tread member.

7. The tire according to claim 2, wherein each of the magnetic poles is a wire, and wherein a side surface that extends along an axis of the wire member is provided with a planner surface which faces the contact surface of the tread member.

8. A tire comprising:
a tread member which has a contact surface made of an elastomer whose viscoelasticity is changed by applying an electric field; and
a pair of electrodes which are located in the tread member or a tire constructing member located at a radial inside of the tread member so that the pair of electrodes are arranged with an interval therebetween, and which apply the electric field to a contact surface side of the tread member,
wherein the electric field is applied to the contact surface side by applying a potential difference between the pair of electrodes by an electric power source,
wherein each of the electrodes is located in the tread member or an elastomer member located at the radial inside of the tread member, and each of the electrodes is a wire extending along a circumferential direction of the tire to be a spiral shape,
wherein each of the electrodes is a wire, and wherein a side surface that extends along an axis of the wire member is provided with a planner surface which faces the contact surface of the tread member.

9. A tire comprising:
a tread member which has a contact surface made of an elastomer whose viscoelasticity is changed by applying a magnetic field; and
a pair of magnetic poles which are located in the tread member or a tire constructing member located at a radial inside of the tread member so that the pair of magnetic poles are arranged with an interval therebetween, and which apply the electric field to a contact surface side of the tread member,
wherein at least one of the magnetic poles is made of an electromagnet,
wherein each of the magnetic poles is located in the tread member or an elastomer member located at the radial inside of the tread member, and which extend in a circumferential direction of the tire so that the magnetic poles extend along each other,
wherein each of the magnetic poles is a wire, and wherein a side surface that extends along an axis of the wire member is provided with a planner surface which faces the contact surface of the tread member.

10. A tire comprising:
a tread member which has a contact surface made of an elastomer whose viscoelasticity is changed by applying an electric field; and
a pair of electrodes which are located in the tread member or a tire constructing member located at a radial inside of the tread member so that the pair of electrodes are arranged with an interval therebetween, and which apply the electric field to a contact surface side of the tread member,
wherein the electric field is applied to the contact surface side by applying a potential difference between the pair of electrodes by an electric power source,
wherein each of the electrodes is located in the tread member or an elastomer member located at the radial inside of the tread member, and each of the electrodes is a wire extending along a circumferential direction of the tire to be a spiral shape,
wherein the elastomer member is a carcass member, a belt member disposed at a radial outside of the carcass member, or a ribbon-shaped member which is disposed at a radial outside of the carcass member and which is wound in a spiral shape extending in a circumferential direction of the tire,
wherein the electrodes are composed of part of wire members which are provided in the carcass member so as to be parallel to each other, or part of wire members provided in the belt member so as to be parallel to each other, or each of the electrodes is composed of a wire member provided in the ribbon-shaped member.

11. The tire according to claim 1, further comprising a power generation element, a power storage element, or a power reception portion of a non-contact power supply system, each of which is attached to a tread portion or a side portion of the tire and each of which is connected to the electrodes to supply electrical potential or current to the electrodes.

12. The tire according to claim 2, further comprising a power generation element, a power storage element, or a power reception portion of a non-contact power supply system, each of which is attached to a tread portion or a side portion of the tire and each of which is connected to the magnetic poles to supply current to the magnetic poles.

13. A tire comprising:
a tread member which has a contact surface made of an elastomer whose viscoelasticity is changed by applying an electric field; and
a pair of electrodes which apply the electric field to a contact surface side of the tread member,
wherein the electric field is applied to the contact surface side by applying a potential difference between the pair of electrodes by an electric power source,
one of the pair of electrodes is located in a block portion provided at the contact surface side of the tread member.

14. A vehicle having a tire according to claim 1, the vehicle comprising a controller for controlling electrical potential or an amount of current supplied to the electrodes in response to an operation state or behavior of the vehicle.

15. A vehicle having a tire according to claim 2, the vehicle comprising a controller for controlling an amount of current supplied to the magnetic poles in response to an operation state or behavior of the vehicle.

16. A traffic control system comprising:
a detection device for detecting condition of a road surface, weather condition, a state of traffic, an operation state of a vehicle, or behavior of the vehicle;
a traffic controller which transmits a control signal regarding electrical potential or an amount of current to be supplied to the electrodes or the magnetic poles to a controller of the vehicle which has all the features described in claim 14 and which exists in a certain area.

17. A traffic control system comprising:
a detection device for detecting condition of a road surface, weather condition, a state of traffic, an operation state of a vehicle, or behavior of the vehicle;
a traffic controller which transmits a control signal regarding an amount of current to be supplied to the magnetic poles to a controller of the vehicle which has all the features described in claim 15 and which exists in a certain area.
